(19) United States
(12) Patent Application Publication
(10) Pub. No.: US 2026/0111612 A1
(43) Pub. Date: Apr. 23, 2026

(54) Training Based Dynamic Cryptographic Acceleration with a Neural Processing Unit

(71) Applicant: Dell Products L.P., Round Rock, TX (US)

(72) Inventors: Gowrishankar Rudraprakash, Bengaluru (IN); Shekar Babu Suryanarayana, Bangalore (IN); Aniket Surekar, Nanded (IN); Karunakar Poosapalli, Bangalore (IN)

(21) Appl. No.: 18/921,227

(22) Filed: Oct. 21, 2024

(51) Int. Cl. G06F 21/72; G06F 9/4401; G06N 20/00

(52) U.S. Cl. CPC G06F 21/72; G06F 9/4403; G06N 20/00

(57) ABSTRACT

A firmware management operation. The firmware management operation includes providing an information handling system with a distributed unified BIOS; identifying a processor environment installed on an information handling system from a plurality of processor environments, the processor environment comprising a processor architecture; and, performing a cryptographic acceleration management operation, the cryptographic acceleration management operation accelerating performance of a cryptographic operation.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture; and, performing a cryptographic acceleration management operation, the cryptographic acceleration management operation accelerating performance of a cryptographic operation.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; identifying a processor environment installed on an information handling system from a plurality of processor environments; performing a cryptographic acceleration management operation, the cryptographic acceleration management operation accelerating performance of a cryptographic operation.

In another embodiment the invention relates to a computer-readable storage medium embodying computer program code, the computer program code comprising computer executable instructions configured for: providing an information handling system with a distributed BIOS; identifying a processor environment installed on an information handling system from a plurality of processor environments; performing a cryptographic acceleration management operation, the cryptographic acceleration management operation accelerating performance of a cryptographic operation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system (IHS) as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified process flow diagram showing the use of a Neural Processing Unit (NPU) to process a cryptographic workload;

FIG. 6 is a simplified block diagram of a cryptographic acceleration framework (CAF) implemented to accelerate the processing of a cryptographic workload;

FIGS. 7a through 7c are a simplified block diagram of the architecture of a training-based, dynamic CAF;

FIG. 8 is a simplified block diagram of the implementation of a Neural Processing Unit (NPU) within a training-based, dynamic cryptographic acceleration framework (CAF);

FIG. 9 is a simplified block diagram of cryptographic object mapping implemented within a training-based, dynamic CAF;

FIGS. 10a and 10b are tables showing example cryptographic workload syntax elements;

FIG. 11 is a simplified block diagram of the performance of certain Modern Standby (MS) operations;

FIGS. 12a and 12 b are a simplified block diagram of the architecture of a Firmware as a Service (FaaS) framework implemented to enable power-efficient MS operations;

FIGS. 13a and 13b are a simplified block diagram showing the performance of certain FaaS operations to enable power-efficient MS operations; and

FIG. 14 is a simplified block diagram showing the prioritization of power optimization for certain IHS components.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that traditional Central Processor Units (CPUs) are not optimized parallel processing. In contrast, a Neural Processing Unit (NPU) is a specialized processor chip that is optimized for parallel processing, matrix operations, and nonlinear transformations. As such, these abilities make an NPU ideal for tasks such as deep learning inference and efficient execution of complex neural network computations commonly associated with artificial intelligence (AI) and machine learning (ML) tasks.

Likewise, various aspects of the invention reflect an appreciation that the evolution of current cryptographic algorithms processed by CPUs can lead to performance degradation of due to their computational intensity. As a result, the execution of other tasks may be negatively affected, which in turn may have a negative impact on system responsiveness and efficiency. Accordingly, various aspects of the invention reflect an appreciation that offloading cryptographic operations to one or more NPUs may ease computational burdens on an IHS’s CPU, enabling it to prioritize other tasks while leveraging the NPU's faster and more efficient cryptographic processing capabilities. Consequently, various aspects of the invention reflect an appreciation that certain CPU manufacturers are now beginning to integrate NPUs alongside traditional CPU cores.

Various aspects of the invention reflect an appreciation that the use of neural cryptography has become more common with the advent of faster and more sophisticated encoder and decoder algorithms. However, various aspects of the invention likewise reflect an appreciation that such algorithms may not perform optimally when executed on traditional CPUs, yet they may when run on an associated NPU. Nonetheless, various aspects of the invention reflect an appreciation that current NPU implementations are not optimized to seamlessly accept and execute cryptographic workloads. Instead, it is not uncommon to have dependencies on CPU core pipeline instructions and memory maps, which can delay execution of an NPU’s workload.

Likewise, various aspects of the invention reflect an appreciation that heterogeneous workloads accessing multiple cryptographic algorithms, such as SHA256, RSA, Post-Quantum, and so forth, may result in an increased burden on a systems CPU, which in turn may cause inefficiency and slower operation. Furthermore, a CPU’s lack of training for cryptographic execution of heterogeneous workloads may result in higher consumption of power. Accordingly, various aspects of the invention reflect an appreciation that cryptographic workloads are typically better suited to be run on an NPU. Various aspects of the invention likewise reflect an appreciation that additional power may be consumed when certain components of an IHS, such as its CPU, Direct Memory Access (DMA), Network Interface Card (NIC) controllers, and related drivers, may remain powered on when operating in Modern Standby (MS) mode.

In particular, a mobile IHS, such as a laptop computer, may experience accelerated battery drain when it is in MS Connected mode, which may in turn lead to accelerated battery depletion, system shutdown, interruption in network connectivity, or potential data loss, or a combination thereof. Various aspects of the invention reflect an appreciation that no current approaches are known for using firmware when an IHS is operation in MS mode to offload high-intensity, power-consuming CPU operations to an associated NPU. Likewise, various aspects of the invention reflect an appreciation that both virtual and physical memory addresses become mapped with network packets, and certain associated input/output (I/O) operations, when an IHS enters MS mode and memory utilization is running, which typically results in associated operational costs and power drain.

Furthermore, various aspects of the invention reflect an appreciation that current CPU or runtime approaches lack the ability to dynamically transition from utilizing multiple (e.g., two or more) Dual In-Line Memory Module (DIMM) operations to optimize (e.g., one) DIMM operations, especially during shifts from high network bandwidth (e.g., 5G wireless) to low bandwidth (e.g., 2G wireless) operations. As a result, it is possible that opportunities may be missed for reducing power consumption. Additionally, buffers are continuously mapped to the DMA controller during Non-Volatile Memory Express (NVMe) memory operations, causing it to remain active and contribute to sustained power consumption.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

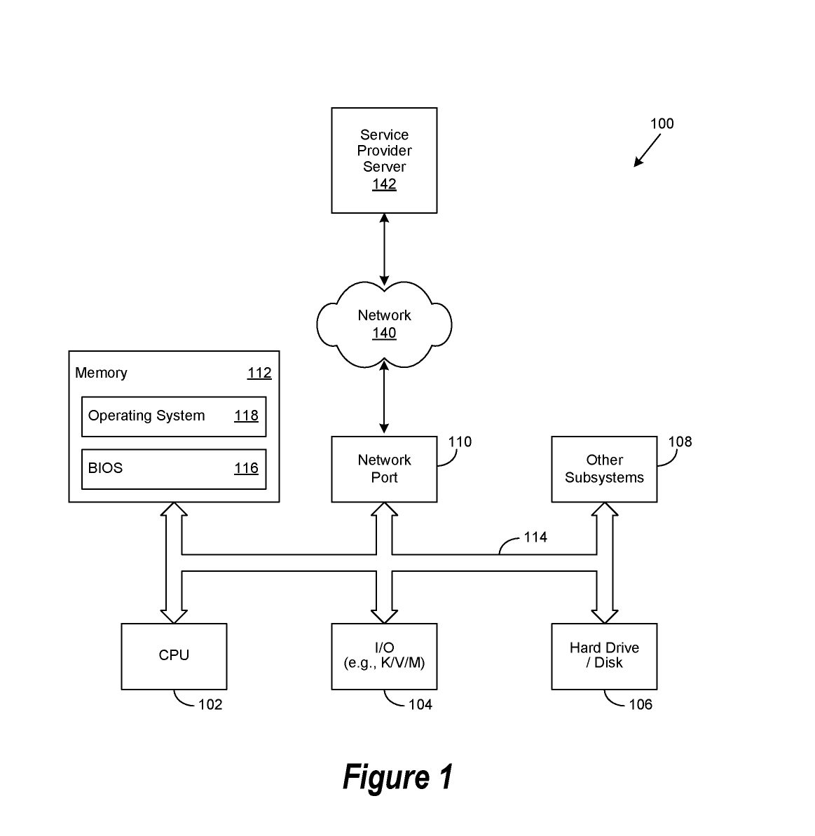

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS’s 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS’s 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS’s 100 initialization and startup within an .efi file, rather than on its associated firmware. In typical implementations, the .efi file may be stored on a special memory partition known as an EFI System Partition (ESP), which also contains the IHS’s 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of one or more cryptographic acceleration management (CAM) operations.

A CAM operation, as used herein, broadly refers to any function, task, procedure, or process performed, directly or indirectly, within a multi-processor operating environment, or an architecture-specific distributed firmware management platform (ASDFMP), both of which are described in greater detail herein, to accelerate the performance of one or more cryptographic operations familiar to skilled practitioners of the art. In various embodiments, the one or more CAM operations may include the performance of one or more cryptographic algorithm management operations, one or more cryptographic object management operations, one or more cryptographic key management operations, one or more cryptographic encryption operations, or one or more cryptographic decryption operations, or a combination thereof, as described in greater detail herein. In various embodiments, one or more Neural Processing Units (NPUs) may be implemented for use in the performance of one or more CAM operations. In various embodiments, one or more CAM operations may be implemented as a CAM protocol. In certain embodiments, the firmware management operation may be performed during operation of an IHS 100. In various embodiments, performance of the firmware management operation may result in the realization of improved operation of an IHS 100.

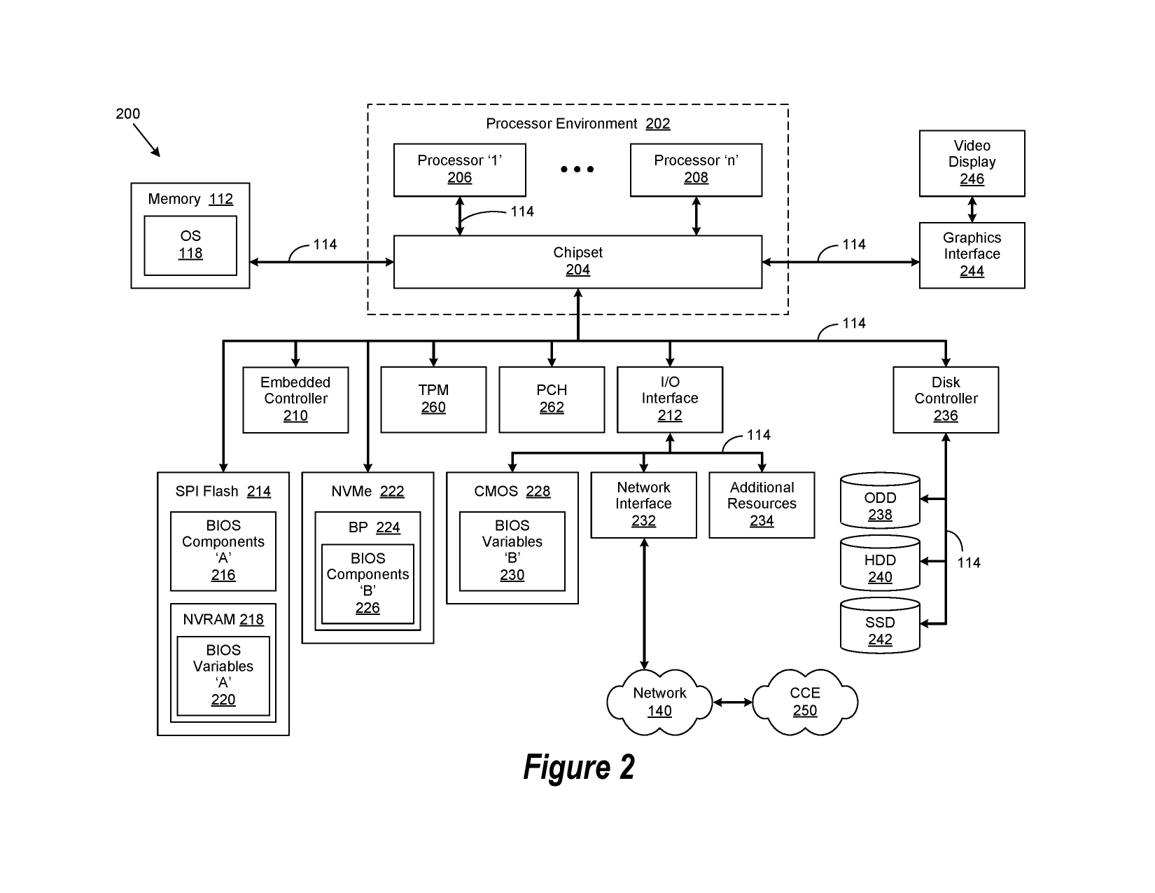

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, one or more of processors ‘1’ 206 through ‘n’ 208 may be implemented as multi-core processors. As another example, processor ‘1’ 206 may be implemented as a multi-core processor in a graphics work station, while processor ‘n’ 208 may be implemented as a Graphics Processing Unit (GPU), familiar to skilled practitioners of the art. In various embodiments, one or more of the processors ‘1’ 206 through ‘n’ 208 implemented within a PE 202 may be implemented as Neural Processing Unit (NPU) type processors. In various embodiments, a Graphics Processing Unit, a Neural Processing Unit, or a combination thereof, may be implemented as separate components within the multi-processor operating environment 200.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft^{®} Windows^{®}, while processor ‘n’ 208 may be implemented to run a version of Linux^{®}.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

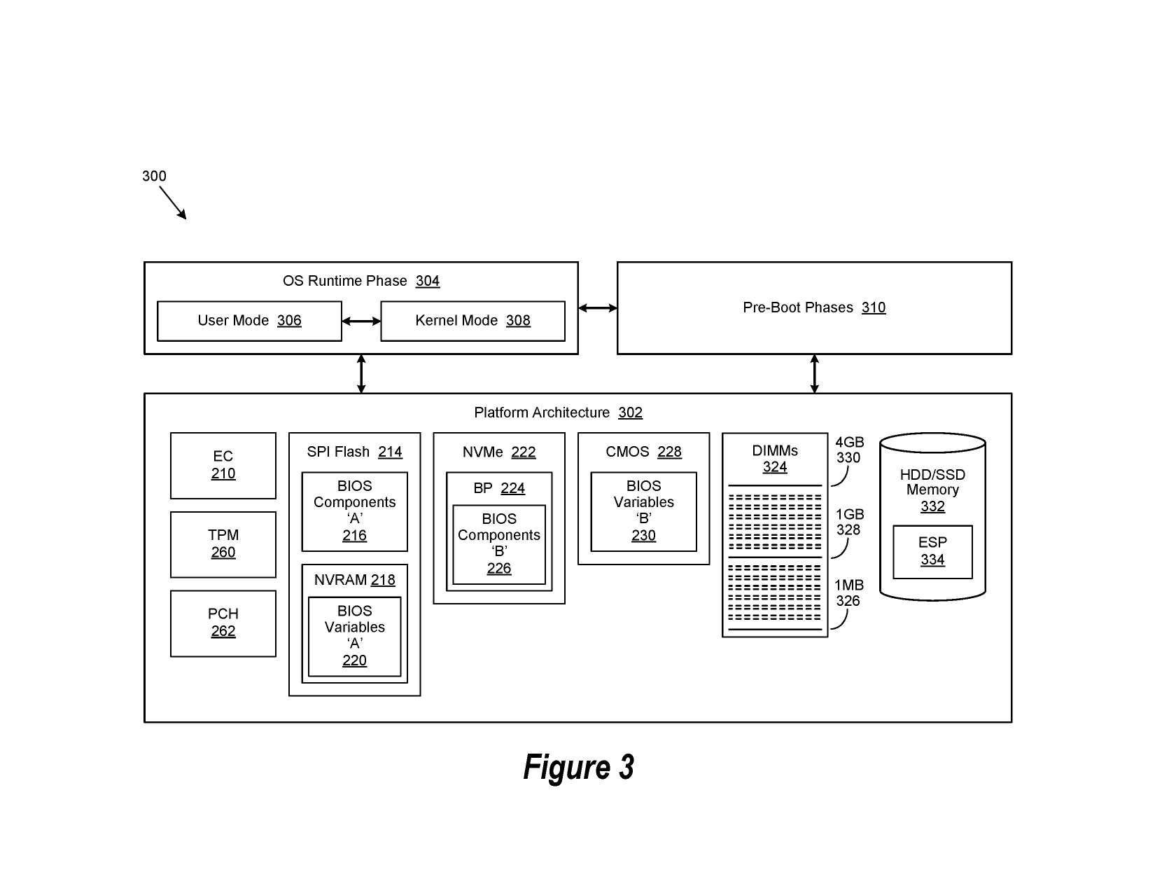

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS’s may utilize different processors (e.g., Intel^{®}, AMD^{®}, Qualcom^{®}, Broadcom^{®}, NVidia^{®}, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel^{®} to control certain data paths and support functions used in conjunction with Intel^{®} processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel^{®}, AMD^{®}, Qualcomm^{®}, Broadcom^{®}, NVidia^{®}, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1GB 328 to 4GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS’s that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

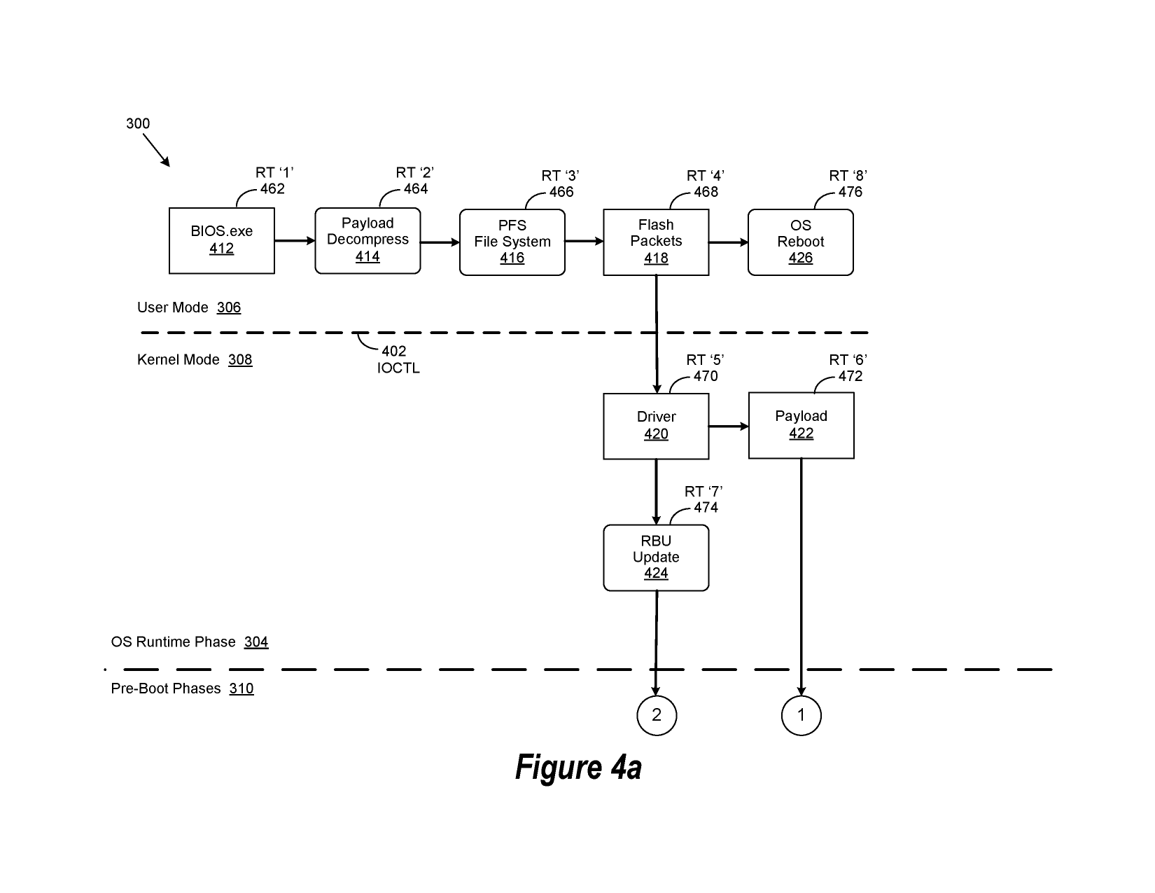

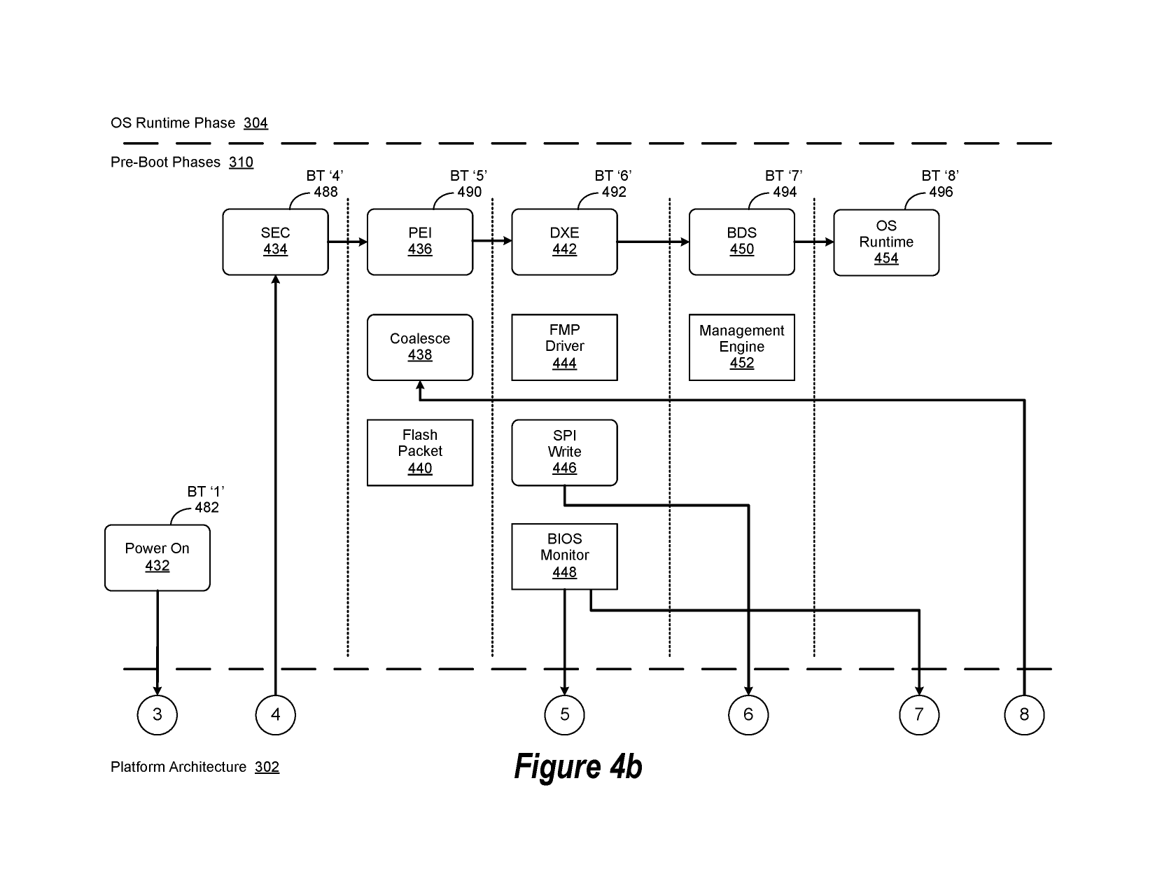

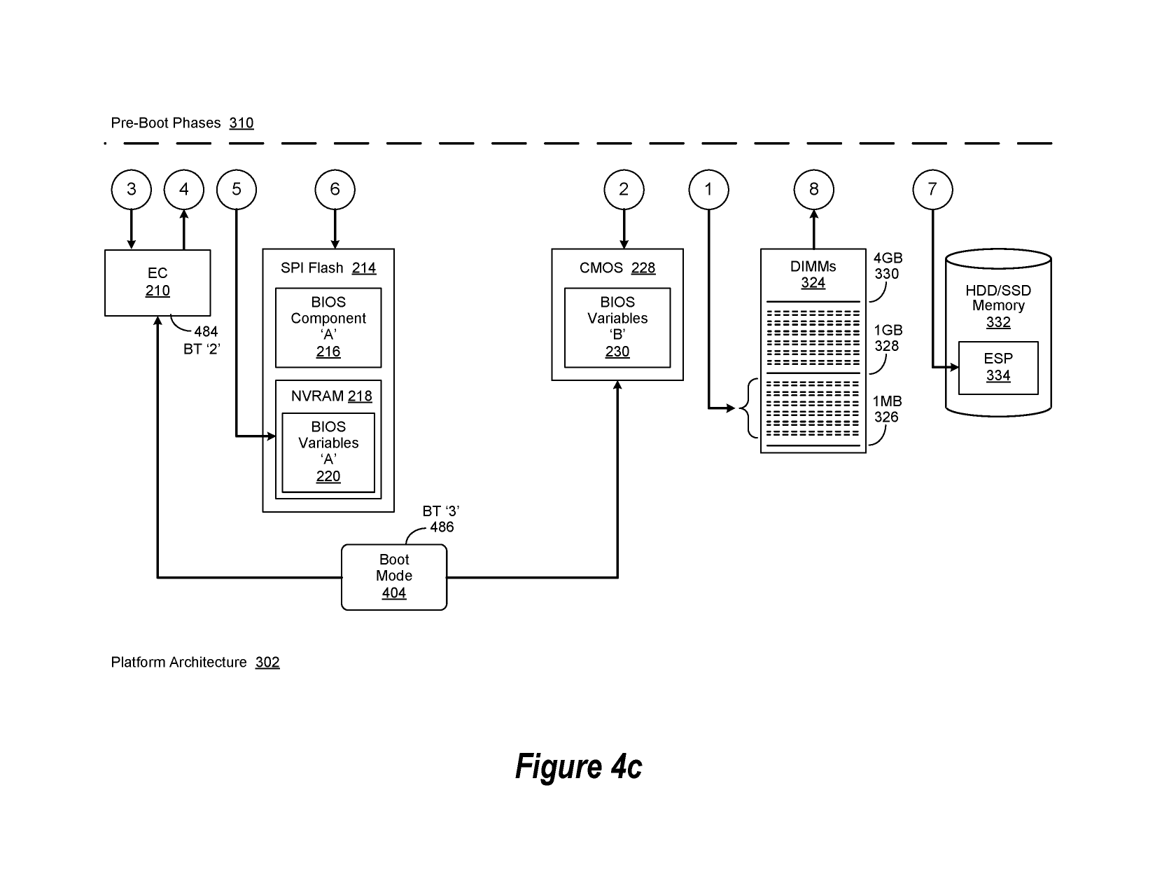

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system’s (IHS’s) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS’s processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell^{®} Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel^{®} Corporation of Santa Clara, California, may be implemented to use the selected boot device in BT step ‘8’ 496 to boot the ASDFMP 300 into an OS runtime 454 state.

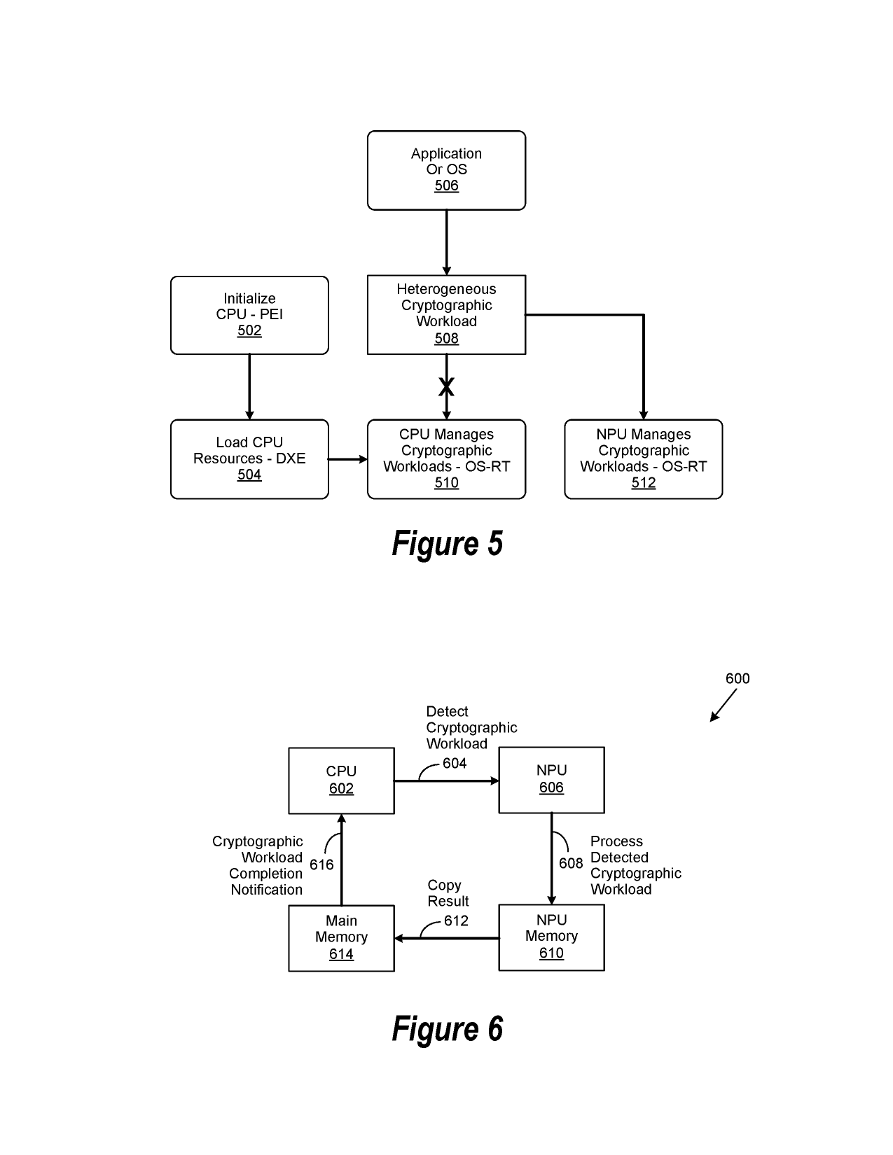

FIG. 5 is a simplified process flow diagram showing the use of a Neural Processing Unit (NPU) implemented in accordance with an embodiment of the invention to process a cryptographic workload. In various embodiments, one or more Central Processing Units (CPUs) implemented on an associated information handling system (IHS) may be initialized 502 during its Pre Extensible Firmware Interface (EFI) Initialization (PEI) pre-boot phase, described in greater detail herein. In various embodiments, certain CPU resources of the IHS may then be loaded 504 during its Driver eXecution Environment (DXE) pre-boot phase, likewise described in greater detail herein.

In various embodiments, a software application, or the Operating System (OS), executing 506 on the IHS may submit one or more heterogeneous cryptographic workloads 508, as described in greater detail herein, for processing. In various embodiments, the IHS may not be implemented with an NPU. If so, then the one or more CPUs may be implemented to process 510 the one or more heterogeneous cryptographic workloads at OS runtime. However, the IHS may be implemented in various embodiments with one or more NPUs in addition to its one or more CPUs. In certain of these embodiments, one or more cryptographic acceleration management (CAM) operations, described in greater detail herein, may be performed to use the one or more NPUs to process 512 the one or more heterogeneous cryptographic workloads at OS runtime.

FIG. 6 is a simplified block diagram of a cryptographic acceleration framework (CAF) implemented in accordance with an embodiment of the invention to accelerate the processing of a cryptographic workload. In various embodiments, one or more cryptographic acceleration management (CAM) operations, described in greater detail herein, may be performed to create a CAF 600. In certain of these embodiments, the one or more CAM operations may be performed to initialize a dedicated memory-mapped pipeline and register set to accelerate the execution of certain cryptographic workloads.

In various embodiments, the CAF 600 may be used in the performance of one or more CAM operations to generate one or more cryptographic light-weight firmware objects, which in certain embodiments may in turn be associated with a particular cryptographic algorithm designed to run efficiently on a Neural Processing Unit (NPU). In various embodiments, one or more CAM operations may be performed to create a real-time (RT) training cryptographic workload-context-aware interface to dynamically sense and offload certain cryptographic workloads to one or more NPUs to improve the performance of certain cryptographic operations. In certain of these embodiments, the context of a particular cryptographic workload broadly refers to its associated type of cryptographic operation, or the one or more cryptographic algorithms used to process it, or its associated category of cryptographic component, or a combination thereof. Various embodiments of the invention reflect an appreciation that dynamically loading certain cryptographic algorithms, based upon a particular context, may facilitate ensuring that only the most relevant cryptographic algorithms are loaded into memory, thereby reducing resource overhead and improving overall system efficiency.

Various embodiments of the invention likewise reflect an appreciation that accelerating the encryption and decryption of a cryptographic key may result in improved performance, faster execution times, and the use of less power to do so. In various embodiments, one or more CAM operations may be performed to optimize one or more cryptographic Application Programming Interfaces (APIs) for use with one or more NPUs. In various embodiments, a firmware cryptographic performance engine may be implemented to securely and efficiently process certain heterogeneous cryptographic workloads.

Referring now to FIG. 6, one or more CAM operations may be performed to monitor the operation of a particular Central Processing Unit (CPU) 602 to detect 604 the submission of a particular cryptographic workload for processing. In certain of these embodiments, one or more CAM operations may be performed to route a detected 604 cryptographic workload to one or more NPU 606 cores for processing 608. In various embodiments, one or more CAM operations may be performed to copy the results of processing the cryptographic workload from the memory 610 of the one or more NPU 606 cores that processed it to the main memory 614 of the IHS. In various embodiments, one of more CAM operations may be performed to provide a notification 616 to the CPU 602 that the processing of the cryptographic workload has been completed and its associated results have been copied to the main memory 614 of the IHS.

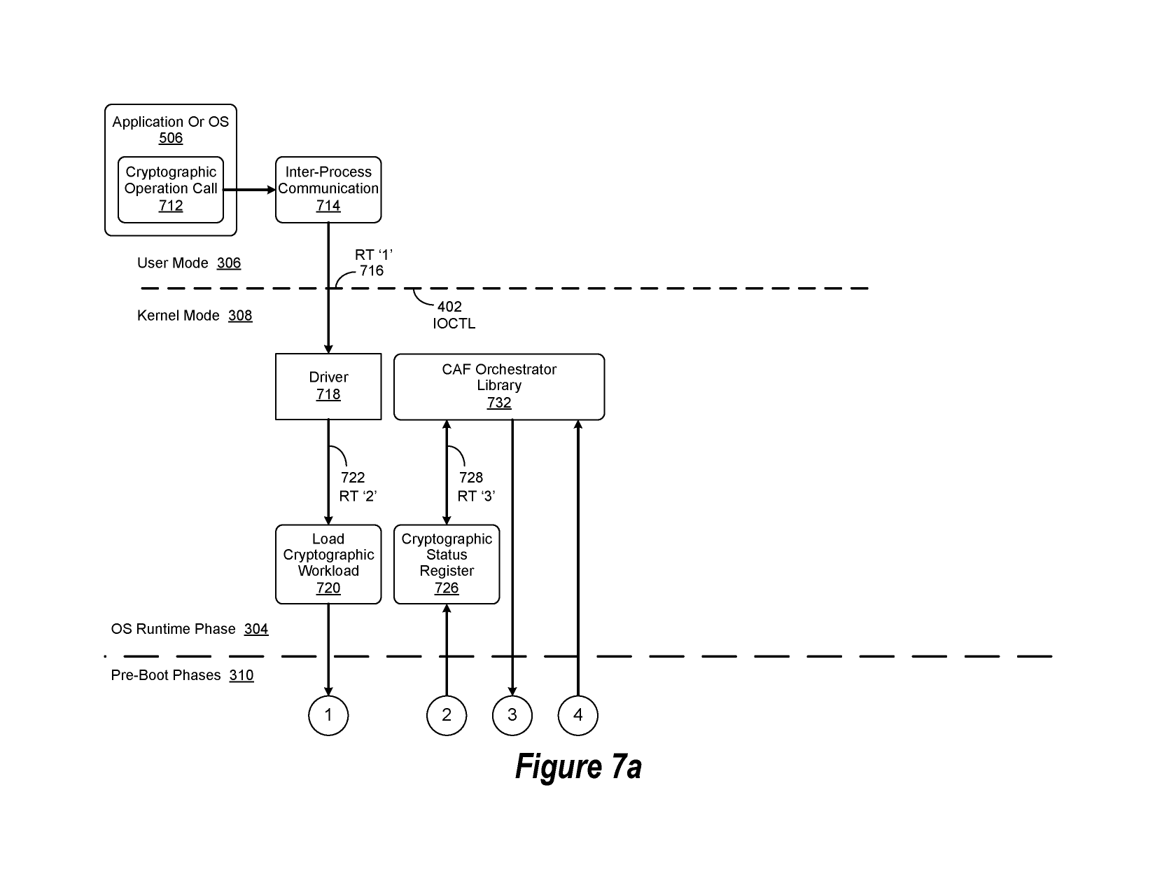

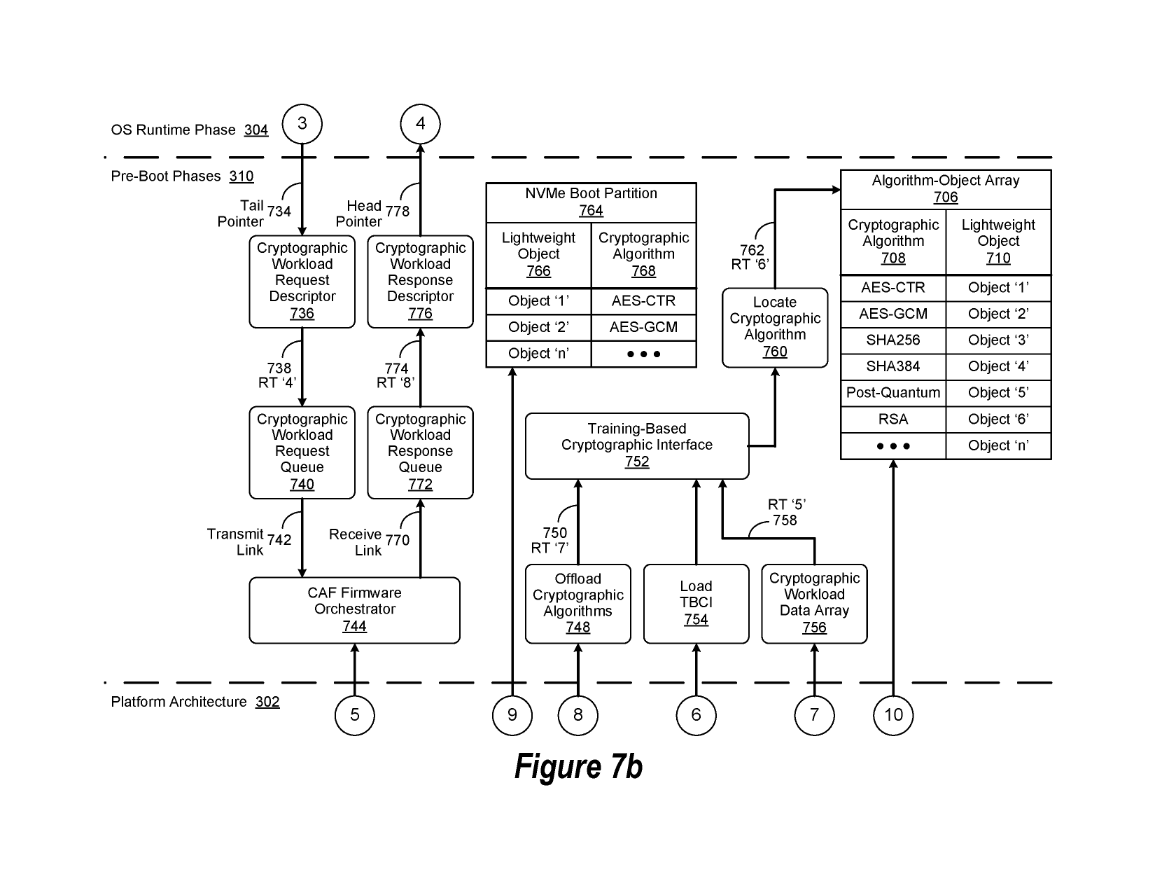

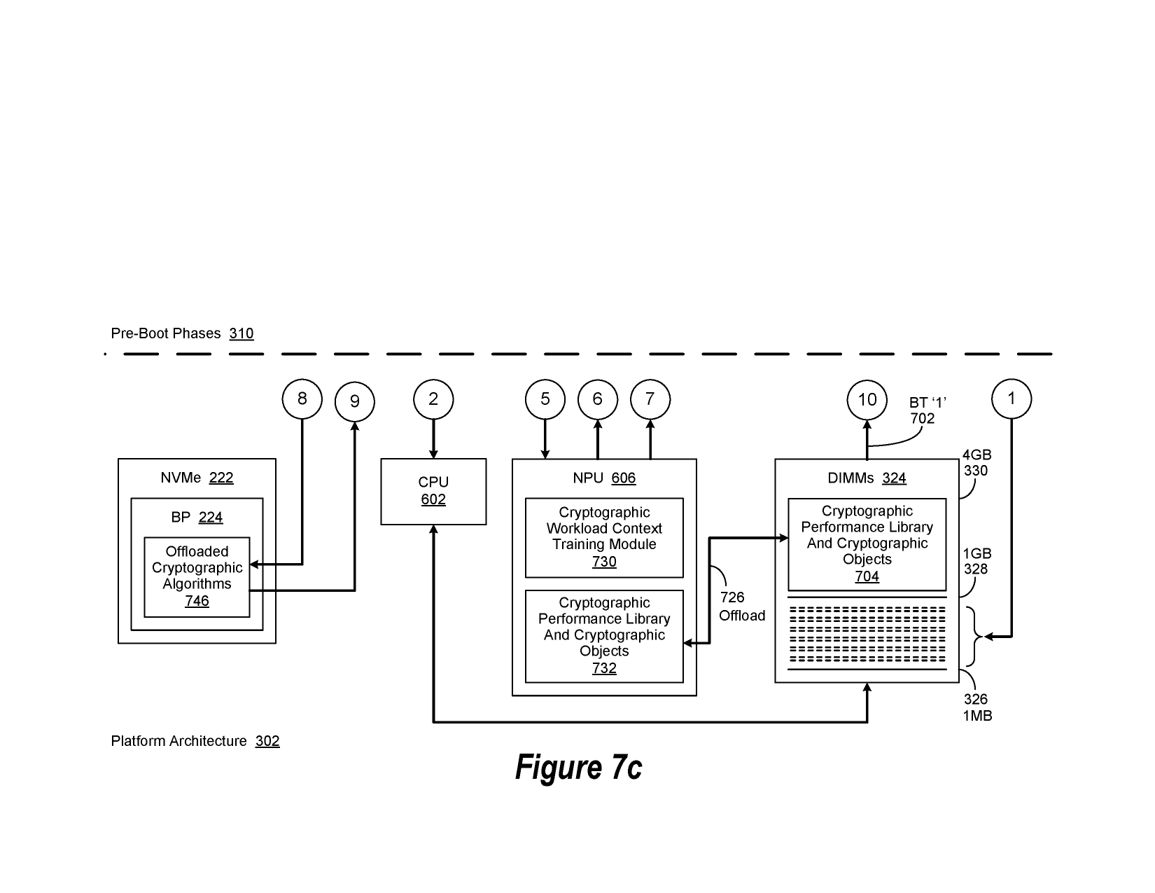

FIGS. 7a through 7c are a simplified block diagram of the architecture of a training-based, dynamic cryptographic acceleration framework (CAF) implemented in accordance with an embodiment of the invention. In various embodiments, an information handling system (IHS) may be implemented to include an OS runtime phase 304, various pre-boot phases 310, and a platform architecture 302, as described in greater detail herein. In various embodiments, the OS runtime phase 304 may be implemented to include a user mode 306 and a kernel mode 308, as likewise described in greater detail herein. Likewise, as described in greater detail herein, an Input/Output Control (IOCTL) 402 operation, familiar to those of skill in the art, may be performed in various embodiments to switch between user mode 306 and kernel mode 308.

In various embodiments, as described in greater detail herein, the platform architecture 302 may be implemented to include one or more Non-Volatile Memory Express (NVMe) 222 memory devices, one or more Central Processing Units (CPUs) 602, one or more Neural Processing Units (NPUs) 606, and one or more dual in-line memory modules (DIMMs) 324, or a combination thereof.

In various embodiments, the one or more NVMe 222 memory devices may be implemented to include a boot partition (BP) 224, described in greater detail herein. In various embodiments, as described in greater detail herein, the BP 224 may be implemented to receive, store, and provide certain offloaded cryptographic algorithms 746. In various embodiments, one or more CAM operations may be performed to receive, store, or provide one or more offloaded cryptographic algorithms 746 stored in the BP 224.

In various embodiments, the one or more NPUs 606 may be respectively implemented to include a cryptographic workload context training 730 module, or a cryptographic performance library 732, or both. In various embodiments, the cryptographic performance library 732 may be implemented to store one or more cryptographic objects, described in greater detail herein. In various embodiments, one or more CAM operations may be performed to offload 726 the cryptographic performance library 732, or one or more of the cryptographic objects it may contain, or a combination of the two, to a designated storage location 704 within the one or more DIMMs 324.

In various embodiments, a software application, or the OS, 506 running on an associated IHS may submit 712 a call for the IHS to perform a particular cryptographic operation. Skilled practitioners of the art will be familiar with a cryptographic operation, which in general refers to any task, function, operation, procedure, or process performed, directly or indirectly, that involves the use of a cryptographic key, likewise familiar to skilled practitioners of the art, to digitally encrypt, decrypt, or sign one or more data elements, or to verify a digital signature associated therewith. In various embodiments, one or more cryptographic algorithms may be used in the performance of a particular cryptographic operations.

In general, cryptographic algorithms can be classified into one of three primary categories. The first category is hash functions, which are one-way algorithms that take variable-length input and produce a fixed-length output, such as variants of a Secure Hash Algorithm (SHA). The second category is asymmetric algorithms, which are public-key algorithms that use paired public and private keys for encryption and decryption, such as Rivest-Shamir-Adleman (RSA). The third category is symmetric algorithms, which use the same key for both encryption and decryption, such as Advanced Encryption Standard (AES) and Data Encryption Standard (DES). Various embodiments of the invention reflect an appreciation that is not uncommon to use combinations of two or more cryptographic algorithms, or variants thereof, in the performance of a particular cryptographic operation.

In various embodiments, the submitted 712 call to perform a cryptographic operation may include a cryptographic workload, or a reference to its storage location. In certain of these embodiments, the storage location of the cryptographic workload may be one or more memory devices directly or indirectly implemented within or on the IHS, a cloud-based storage location, or a combination thereof. As used herein, a cryptographic workload refers to any task, function, operation, procedure, or process performed, directly or indirectly, that involves the use of one or more cryptographic algorithms, or one or more associated cryptographic components, or a combination thereof, to perform one or more associated cryptographic operations. As likewise used herein, a cryptographic component broadly refers to any fundamental building block of a cryptographic system, algorithm, or protocol.

Various embodiments of the invention reflect an appreciation that the use of such cryptographic components may assist in ensuring the confidentiality, integrity, and authenticity of data. Examples of such cryptographic components include low-level cryptographic algorithms, described in greater detail herein, such as ciphers (e.g., AES), hashes (e.g., SHA-256), and message authentication codes (e.g., HMAC), which may be used in various embodiments for encryption, decryption, and data integrity verification. Other examples of cryptographic components include cryptographically secure random number generators, typically used to produce high-quality random numbers, which are considered essential for key generation, nonces, and other cryptographic applications. Yet other examples of cryptographic components include implementations of certain secure communications protocols, such as Transport Layer Security (TLS) and Secure Shell (SSH), which provide end-to-end encryption and authentication for network communications.

Another example of a cryptographic component is a Public Key Infrastructure (PKI), which is a commonly implemented framework for authentication and data encryption, comprising components such as registration authorities, certificate authorities, certificate repositories, and certification revocation lists. Yet another example of a cryptographic component are digital signature services, which enable the creation and verification of digital signatures for secure exchanges of data. Skilled practitioners of the art will be aware of the existence of many such examples of cryptographic components. Accordingly, the foregoing is not intended to limit the spirit, scope, or intent of the invention.

In various embodiments, the submitted 712 call to perform a cryptographic operation may in turn be processed 714 by an inter-process communication operation to submit it to a driver 718 in real time (RT) step ‘1’ 716. In various embodiments, the performance of the inter-process communication operation 714 may include the performance of one or more IOCTL 402 operations, described in greater detail herein. In various embodiments, one or more CAM operations may be performed to load 720 one or more cryptographic workloads in RT step ‘2’ 722 into a particular memory location within a the IHS’s main memory, such as 1MB to 1 GB of DIMMs 324.

In various embodiments, one or more CAM operations may be performed such that the one or more CPUs 602 are made aware of the presence of the one or more cryptographic workloads within the DIMMs 324. In various embodiments, one or more CAM operations may be performed such that the CPU 602 is used to populate a cryptographic status register 726 with information associated with the cryptographic workloads stored in the DIMMs 324. In various embodiments, the cryptographic status register 726 may be implemented within one or more CPUs 602. In various embodiments, the information populated by the CPU 602 within the cryptographic status register 726 may include the type(s) of cryptographic operations (e.g., SHA-256, AES, RSA, etc.) that may be involved in processing a particular cryptographic workload.

In various embodiments, one or more CAM operations may be performed in RT step ‘3’ 728 to provide certain information stored in the cryptographic status register 726 to a CAF orchestrator library 730. In various embodiments, one or more CAM operations may be performed in RT step ‘3’ 728 to activate the CAF orchestrator library 730 whenever presence of cryptographic operation information is detected within the cryptographic status register 726.

In various embodiments, one or more CAM operations may be performed by the CAF orchestrator library 730 to create a cryptographic operation request descriptor 736. In various embodiments, the cryptographic operation request descriptor 736 may be implemented to generate a cryptographic workload descriptor that describes one or more cryptographic algorithm, one or more cryptographic components, or a combination of the two, as described in greater detail herein, that may be needed to process the cryptographic workload, also described in greater detail herein. In various embodiments, one or more CAM operations may be performed to append the previously generated cryptographic workload descriptor 736 to the cryptographic workload request queue 740 in RT step ‘4’ 738. In certain of these embodiments, the tail pointer 734 of the cryptographic workload request queue may be used in the performance of the one or more CAM operations to append the previously generated cryptographic workload descriptor 736 to the cryptographic workload request queue 740.

In various embodiments, one or more CAM operations may be performed to convey the cryptographic workload request queue 740 to a CAF firmware orchestrator 744. In certain of these embodiments, a transmit link 742 may be used in the performance of the one or more CAM operations to convey the cryptographic workload request queue 740 to the CAF firmware orchestrator 744. In various embodiments, the CAF firmware orchestrator 744 may be used in the performance or one or more CAM operations to orchestrate the submission of the cryptographic workload request queue 740 to the one or more NPUs 606. In various embodiments, the submission of the cryptographic workload request queue 740 may be performed in the one or more CAM operations such that the processing of certain cryptographic workloads is offloaded from the one or more CPUs 602 to the one or more NPUs 606. In various embodiments, one or more CAM operations may be performed to update the tail pointer 734 of the cryptographic workload request queue 740 when it is submitted to the one or more NPUs 606.

In various embodiments, one or more CAM operations may be performed to orchestrate the submission of certain information contained in the cryptographic workload request queue 740 to a cryptographic workload context training module 730. In various embodiments, the cryptographic workload context training module 730 may be implemented to use the certain information contained in the cryptographic workload request queue 740 as training data. In various embodiments, the training data may be used by the cryptographic workload context training module 730 in the performance of certain machine learning operations, familiar to those of skill in the art, to learn which cryptographic workloads are more likely to be submitted for processing than others. In certain of these embodiments, the training data may likewise be used by the cryptographic workload context training module 730 to learn which cryptographic algorithms, or cryptographic components, or a combination thereof, are most likely to be respectively associated with each cryptographic workload submitted for processing.

In various embodiments, the contents of one or more NPUs 606 may be used in the performance of one or more CAM operations to load 754 a training-based cryptographic interface (TBCI) 752. In various embodiments, one or more CAM operations may be performed to offload 748 certain cryptographic algorithms to the TBCI 752 in RT step ‘5’758. In certain of these embodiments, one or more CAP operations may be performed in RT step ‘6’ 762 to locate 760 one or more cryptographic algorithms 708 stored in a cryptographic algorithm-object array 706. In various embodiments, the cryptographic algorithm-object array 706 may be implemented to cross-reference a particular cryptographic algorithm 708 to a corresponding lightweight cryptographic object 710.

In various embodiments, the one or more cryptographic algorithms 708 referenced in the cryptographic algorithm-object array 706 may be stored in a particular location 704 within DIMMs 324, as described in greater detail herein. In various embodiments, the one or more NPUs 602 may be used in the performance of one or more CAM operations to offload 748 certain cryptographic algorithms from the TBCI 752 in RT step ‘7’ to the BP 224 of the NVMe memory device 222, where they are stored 746. In various embodiments, one or more CAM operations may be performed to store these offloaded cryptographic algorithms with in a NVMe boot partition table 764. In various embodiments, the NVMe boot partition table 764 may be implemented to cross-reference a lightweight object 766 to a corresponding cryptographic algorithm 768.

In various embodiments, the one or more NPUs 606 may be used in the performance of one or more CAM operations to notify the CAF firmware orchestrator 744 when a particular cryptographic workload has been processed. In various embodiments, the CAF firmware orchestrator may be implemented to update the status of a cryptographic workload response queue 772 via a receive link 770 as the processing of each cryptographic workload is completed. In various embodiments, one or more CAM operations may be performed in RT step ‘8’ to identify a cryptographic workload response descriptor 776 corresponding to each completed cryptographic workload.

In various embodiments, one or more CAM operation may be performed use the head pointer 778 of the cryptographic workload response queue 772 to identify the cryptographic workload descriptor 776 corresponding to the most-recently completed cryptographic workload. In various embodiments, one or more CAM operations may then be performed to provide the completion status of each cryptographic workload descriptor 776 to the CAF orchestrator library 732. In various embodiments, the CAF orchestrator library may be used in the performance of one or more CAM operations to update the completion status of each cryptographic workload descriptor 776 in the cryptographic status register 726.

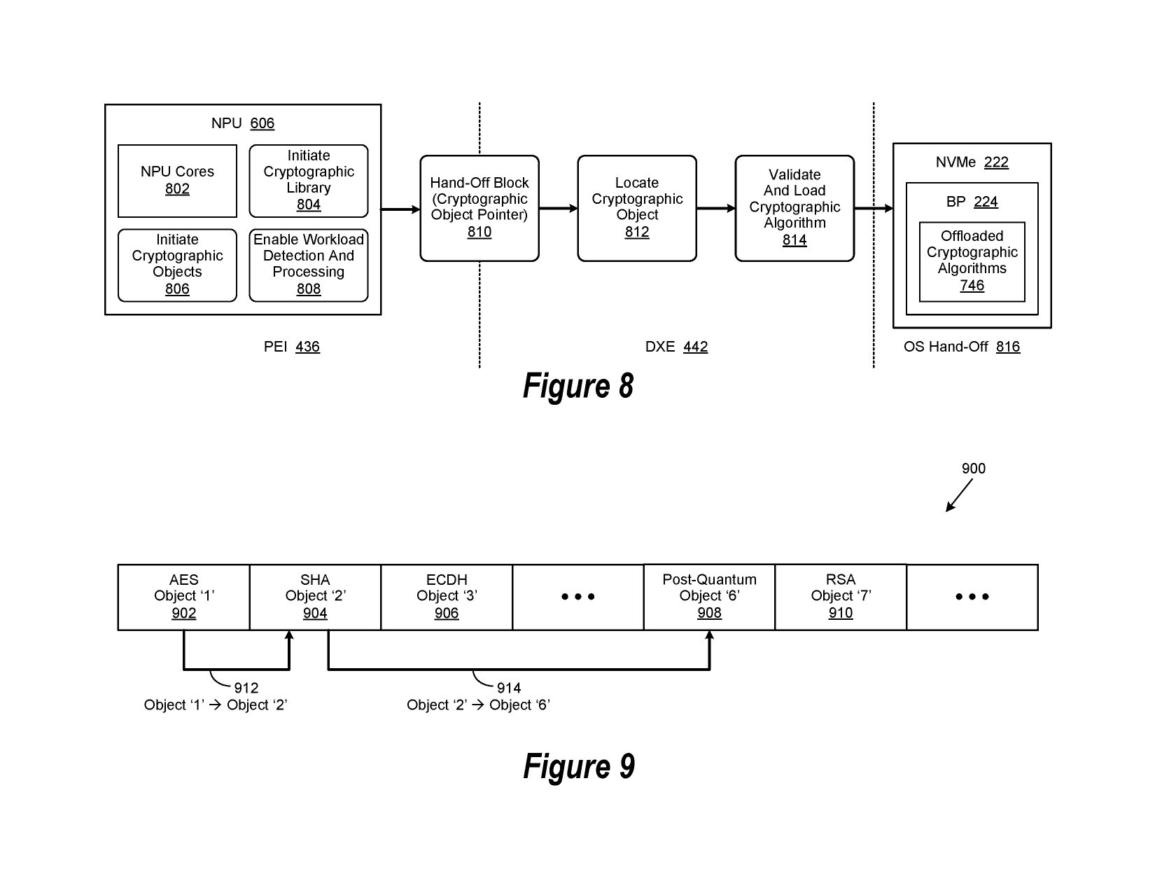

FIG. 8 is a simplified block diagram of the implementation of a Neural Processing Unit (NPU) within a training-based, dynamic cryptographic acceleration framework (CAF) implemented in accordance with an embodiment of the invention. In various embodiments, one or more cryptographic acceleration management (CAM) operations, described in greater detail herein, may be performed during the Pre Extensible Firmware Interface (EFI) Initialization (PEI) phase of pre-boot operations, likewise described in greater detail herein to initialize a Neural Processing Unit (NPU) with a memory map containing addresses of lightweight cryptographic objects. In certain of these embodiments, such lightweight cryptographic objects may reference a cryptographic algorithm. Examples of such cryptographic algorithm include the Advanced Encryption Standard (AES), Rivest–Shamir–Adleman (RSA), Secure Hash Algorithm (SHA), and so forth, which are subsequently loaded into the main memory of an associated information handling system (IHS).

In various embodiments, a lightweight cryptographic object may be implemented to include, or be associated with, a corresponding cryptographic algorithm Application Programming Interface (API). In various embodiments, a particular cryptographic algorithm API may be implemented according to the context of an associated workload, described in greater detail herein. In various embodiments, a particular cryptographic algorithm may be initialized by a training module implemented withing the training-based, dynamic CAF, as described in greater detail herein. In certain of these embodiments, the training module may be implemented to detect whether a particular cryptographic workload involves a cryptographic operation, described in greater detail herein, and if so, identify supported cryptographic algorithms that may be used to process it. In various embodiments, lightweight cryptographic objects corresponding to their respectively-supported cryptographic algorithms may be created for cryptographic workloads involving one or more cryptographic operations.

In various embodiments, information associated with one or more cryptographic objects may be conveyed to the Driver Execution Environment (DXE) pre-boot phase in the form of Hand-Off Blocks (HOBs), familiar to skilled practitioners of the art. In various embodiments, referencing such algorithmic objects during the DXE pre-boot phase may result in the loading of corresponding lightweight cryptographic objects containing specified cryptographic algorithms into the main memory of an associated IHS. In certain of these embodiments, such cryptographic algorithms may be offloaded to a boot partition (BP) implemented within the IHS’s Non-Volatile Memory express (NVMe) memory device. In various embodiments, the cryptographic workload or software application operating in user mode may be implemented to store its relevant data in the system’s main memory, which in certain embodiments may be accessible through inter-process communication methods such as Input/Output Control (IOCTL).

In various embodiments, a CAF may be implemented to prepare a cryptographic lightweight firmware object to be linked with certain optimized cryptographic algorithms designed to run efficiently on an NPU. In various embodiments, the Central Processing Unit (CPU) of an associated IHS may be implemented to maintain a workload-specific context. In certain of these embodiments, the CPU may be implemented to initialize a cryptographic status register (CSR) when the CPU encounters a cryptographic operation. In various embodiments, the CSR may be implemented to register configured cryptographic operations that may be performed by the CAF. In various embodiments, one of more CSRs may be implemented such that software applications can specify certain parameters. such as cryptographic algorithms (e.g., AES, RSA, SHA etc.), cryptographic key lengths, and operation modes (e.g., encryption, decryption).

In various embodiments, the CAF may be implemented to offload certain computationally intensive symmetric and asymmetric cryptography operations from the CPU, while also facilitating communication via cryptographic operation queues. In various embodiments, such cryptographic operation queues may be implemented as circular linked buffers, which in certain embodiments may be implemented to be available in memory cache for faster access request and response. In various embodiments, a cryptographic operation request may be implemented as a cryptographic operation request queue for software-generated cryptographic operation request descriptors and a cryptographic operation response may be implemented as a cryptographic operation response queue for firmware-generated cryptographic operation response descriptors.

In various embodiments, a cryptographic operation request descriptor may be written to a cryptographic operation request queue upon initiation of a cryptographic operation request generated by a software application or an Operating System (OS) running on an IHS. In certain of these embodiments, the tail pointer of the cryptographic operation request queue may be updated to indicate the addition of a new request. In various embodiments, the CAF may be implemented to perform a new cryptographic operation in response to reading the cryptographic operation request queue. In certain of these embodiments, the CAF may be implemented to update the head pointer of the cryptographic operation request queue subsequent to writing a cryptographic operation response descriptor to the cryptographic operation response queue. In various embodiments, a CAF orchestrator library, described in greater detail herein, may be implemented to interpret a cryptographic operation request from the cryptographic operation request queue and generate an associated cryptographic operation request descriptor containing relevant cryptographic algorithm information for dynamic linking and loading. Various embodiments of the invention reflect an appreciation that the foregoing approach may facilitate improving performance, security, and compatibility with various cryptographic standards and protocols.

In various embodiments, one or more CAM operations may be performed to create a CAF by initializing a dedicated memory mapped-pipeline and its associated register set to accelerate execution of certain cryptographic workloads. In various embodiments, a cryptographic workload context training module may be implemented to detect a particular cryptographic workload and identify its cryptographic context. In certain of these embodiments, the cryptographic workload context training module may be implemented to evaluate such cryptographic context, learn from it, and store the resulting learned information in cache memory to reduce the need for reevaluation during subsequent encounters with the same context. In various embodiments, the cryptographic workload context training module may be implemented to access a relevant cryptographic light-weight firmware object through a training-based cryptographic interface (TBCI) if the same type of cryptographic workload appears in the cryptographic operation request queue. In various embodiments, the TBCI may be implemented to locate preloaded cryptographic object arrays and access the cryptographic light-weight firmware object via a cryptographic performance interface (CPI) to respectively perform an associated cryptographic operation.

In various embodiments, the TCBI may be implemented to dynamically detect and offload data to one or more NPUs to realize faster cryptographic operation performance. In various embodiments, the TBCI may be implemented to identify dependent sub-object cryptographic algorithms associated with a parent cryptographic object through the use of a cryptographic object-algorithm data array, described in greater detail herein. In various embodiments, a CAF orchestrator library may be implemented to load a particular cryptographic algorithm.

As an example, if the Advanced Encryption Standard (AES) depends upon SHA-256, which in turn depends on Post-Quantum, the parent object AES is interconnected with sub-objects such as SHA-256 and Post-Quantum. Various embodiments of the invention reflect an appreciation that such interconnection ensures that only the cryptographic algorithms required for encryption or decryption of an associated cryptographic workload are offloaded from the BP of an associated NVMe device. To continue the preceding example, AES, SHA-256, and Post-Quantum objects may then be loaded into main memory, resulting in lightweight cryptographic objects. Various embodiments of the invention reflect an appreciation that such dynamic linking of cryptographic objects may facilitate the efficient processing of heterogeneous cryptographic workloads as it ensures only the necessary cryptographic algorithms are offloaded, rather than all cryptographic algorithms.

In various embodiments, the TBCI may be implemented to provide high performance implementations of certain cryptographic functions for a heterogeneous NPU instruction set. In various embodiments, the TBCI may be implemented to automatically takes advantage of any available NPU capabilities. In various embodiments, one or more CAM operations may be performed to assign each cryptographic algorithm with an optimized execution path to achieve optimal performance across multiple NPU cores. In various embodiment, the TBCI interface may be implemented to be architecture-agnostic (e.g., X86, AARCH64, etc.). In various embodiments, a CAF firmware orchestrator may be implemented to provide a single, cross-architecture API to enables seamless execution of cryptographic and features execution across various NPU architectures. In various embodiments, linking of a CAD firmware orchestrator may be implemented whether a cryptographic object is a single-threaded dynamic object, a single-threaded static object, a multi-threaded dynamic object, or a multi-threaded static object.

In various embodiments, one or more CAM operations may be performed to provide basic, low-level functions for forking optimized cryptographic functions to efficiently run on an NPU. Accordingly, NPU execution in such embodiments may be more efficient and faster with the implementation of a CAF orchestrator library. In various embodiments, one or more CAM operations may be performed to ensure consistent interface conventions are followed, including uniform naming conventions and similar composition of prototypes for primitives that refer to different application domains, which is exported as a CAF orchestrator library. Various embodiments of the invention reflect an appreciation that such TBCI abstraction levels are conducive to achieving improved performance by offloading certain cryptographic workloads into the CAF.

Referring now to FIG. 8, an NPU 606 may be implemented in various embodiments to include one or more NPU cores 802. In various embodiments, as described in greater detail herein, an NPU 606 may be used in the performance of one or more CAM operations to initiate 804 a CAF orchestrator library, initiate 806 certain lightweight cryptographic objects, and enable the detection and processing 808 of a particular cryptographic workload, or a combination thereof, in the PEI 436 pre-boot phase of an associated IHS. In various embodiments, as likewise described in greater detail herein, a hand-off block (HOB) 810 may be used in the performance of one or more CAM operations to transfer a cryptographic object pointer from the PEI 436 pre-boot phase to the DXE 442 pre-boot phase of the IHS.

In various embodiments, one or more CAM operations may be performed to locate 812 a lightweight cryptographic object associated with a particular cryptographic workload. In various embodiments, one or more CAM operations may be performed to use a located lightweight cryptographic object to validate and load 814 a corresponding cryptographic algorithm. In certain of these embodiments, one or more CAM operations may be performed to load 814 a validated cryptographic algorithm into the BP 224 of a NVMe 222 memory device as an offloaded 746 cryptographic algorithm. In various embodiments, one or more CAM operations may be performed to provide one or more offloaded 746 cryptographic algorithms during OS hand-off 816.

FIG. 9 is a simplified block diagram of cryptographic object mapping implemented within a training-based, dynamic cryptographic acceleration framework (CAF) implemented in accordance with an embodiment of the invention. In various embodiments, one or more cryptographic acceleration management (CAM) operations, described in greater detail herein, may be performed to create lightweight cryptographic objects 900 corresponding to their respectively-supported cryptographic algorithms. In various embodiments, a training-based, dynamic CAF, described in greater detail herein, may be implemented to prepare a cryptographic lightweight firmware object to be linked with various optimized cryptographic algorithms designed to run efficiently on an NPU.

In various embodiments, one or more CAM operations may be performed to use these cryptographic lightweight objects 900 to reference only those cryptographic algorithms needed to process a particular cryptographic workload, or perform a particular cryptographic operation, both of which are described in greater detail herein, rather than loading all available cryptographic algorithms into the main memory of an associated information handling system (IHS). In various embodiments, one or more CAM operations maybe performed to identify, and link, one or more dependent sub-object cryptographic algorithms associated with a parent cryptographic object. For example, as shown in FIG. 9, cryptographic lightweight objects 900 implemented within a CAF may include object ‘1’ 902 for the Advanced Encryption Standard (AES) algorithm, ‘2’ 904 for Secure Hash Algorithm (SHA), ‘3’ 906 for the Elliptic-Curve Diffie-Hellman (ECDH) algorithm, ‘6’ for the Post-Quantum algorithm, ‘7’ for a Rivest-Shamir-Adleman (RSA) algorithm, as so forth. To continue the example, one or more CAM operations may be performed to link 912 object ‘1’ 902 to object ‘2’ 904, and to likewise link 914 object ‘2’ 904 to object ‘6’ 908.

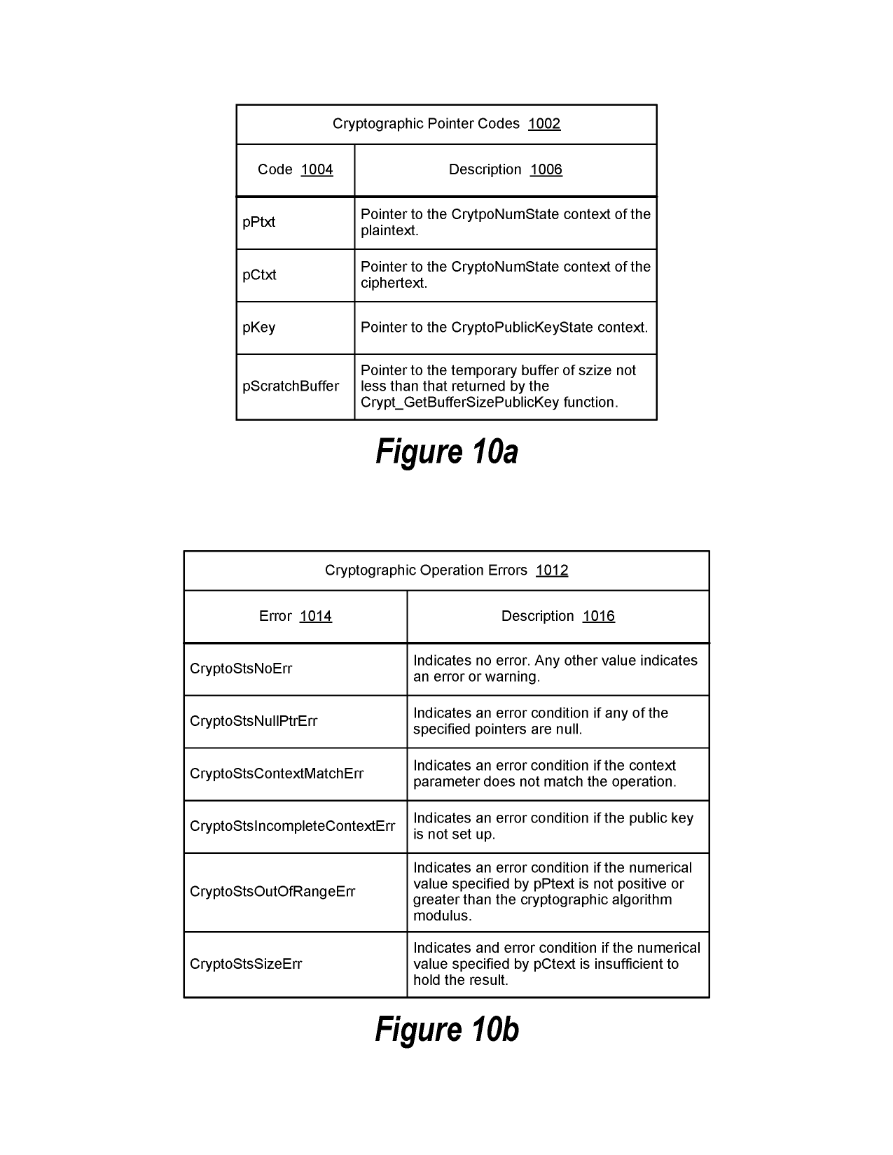

FIGS. 10a and 10b are tables showing example cryptographic workload syntax elements implemented in accordance with an embodiment of the invention. In various embodiments, as shown in FIG. 10a, a cryptographic pointer code 1002 may be used in the performance of one or more a cryptographic acceleration management (CAM) operation, described in greater detail herein. In various embodiments, each cryptographic pointer code 1002 may have a cryptographic pointer code variable name 1004, with a corresponding pointer code description 1006. In various embodiments, a pointer code 1002 may be used in one or more CAM operations according to a cryptographic workload syntax.

For example, a cryptographic encryption operation may be implemented to using the following syntax:

CryptoStatusCrypto_Encrypt(const CryptoNumState* pPtxt, CryptoNumState* pCtxt, const CryptoPublicKeyState* pKey, * pScratchBuffer);CryptoDecrypt:

Likewise, a cryptographic decryption operation may be implemented to use the following syntax:

CryptoStatusCrypto_Decrypt(const CryptoNumState* pPtxt, CryptoNumState* pCtxt, const CryptoPublicKeyState* pKey, * pScratchBuffer);

In various embodiments, as shown in FIG. 10b, a cryptographic operation error 1012 may be used in the performance of one or more CAM operations. In various embodiments, each cryptographic operation error 1012 may have an error code variable name 1014, with a corresponding error code description 1016. In various embodiments, a cryptographic operation error 1012 may be used in one or more CAM operations according to a cryptographic workload syntax.

For example, performance of a cryptographic encryption/decryption operation may result in returning the value of encrypted/decrypted data as follows:

Return Values of Encryption operation:

In these embodiments, the method by which the cryptographic workload syntax is implemented, or used in a CAM operation is a matter of design choice. Accordingly, the foregoing is not intended to limit the spirit, scope, or intent of the invention.

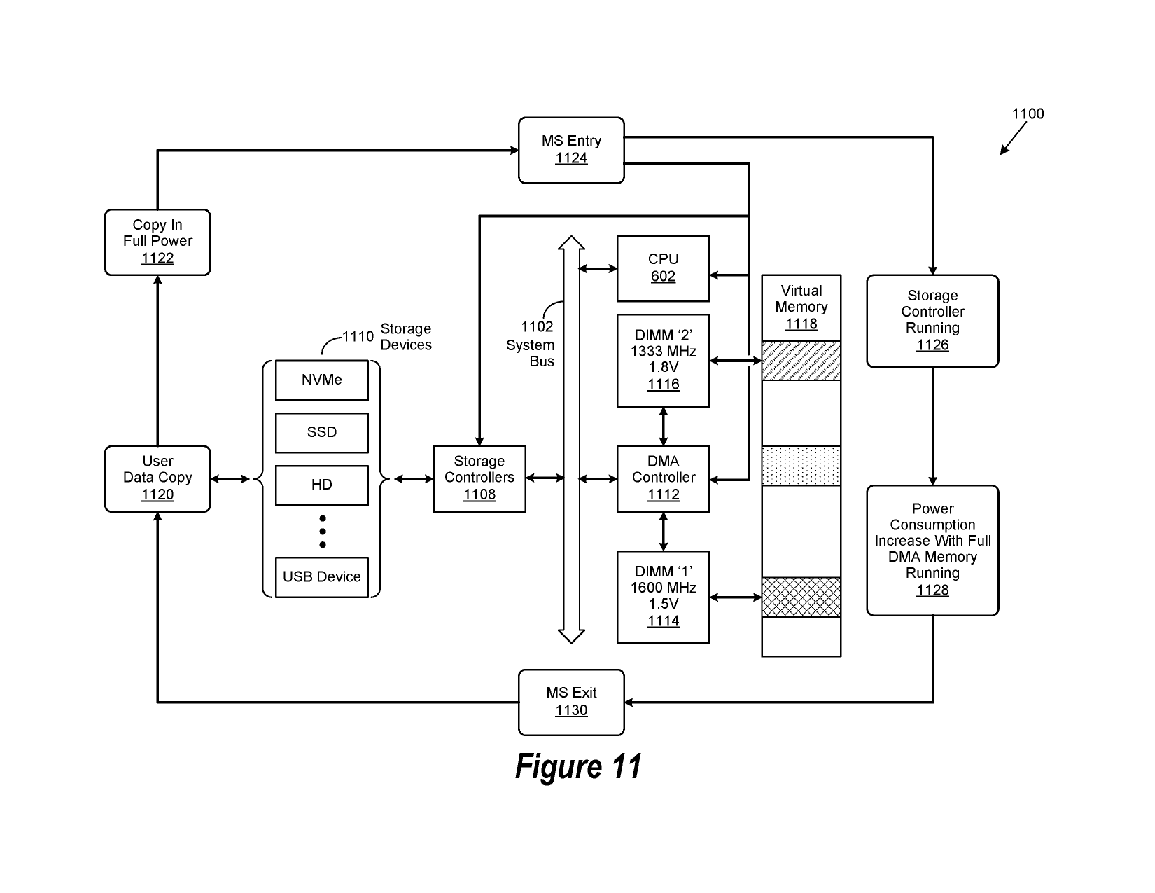

FIG. 11 is a simplified block diagram of the performance of Modern Standby (MS) operations implemented in accordance with an embodiment of the invention. In various embodiments, as described in greater detail herein, an information handling system (IHS) 1100 may be implemented to include one or more Central Processing Units (CPUs) 602, one or more storage controllers 1108, and a Direct Memory Access (DMA) controller 1112, all of which may be interconnected via a system bus 1102. In various embodiments, the one or more storage controllers 1108 may be implemented to control one of more storage devices 1110, such as a Non-Volatile Memory Express (NVMe) device, a solid state disk (SSD) drive, a hard disk (HD), a Universal Serial Bus (USB) memory device, and so forth.

In various embodiments, the DMA controller 1112 may be implemented to control two or more Dual Inline Memory Modules (DIMMs), such as DIMM ‘1’ 1114 and ‘2’ 1116. In various embodiments, the two or more DIMMs may be implemented to run at different speeds (e.g., 1333Mhz, 1600Mhz, etc.), or different operating voltages (e.g., 1.5V, 1.8V, etc.) or a combination of the two. In various embodiments, the two of more DIMMs may be implemented to respectively provide different portions of virtual memory 1118 to the IHS 1100.

In various embodiments, an IHS 100 may be implemented to perform certain Modern Standby operations to improve battery life and provide instant-on readiness when running the Microsoft^{®} Windows^{®} Operating System (OS). Skilled practitioners of the art will be familiar with Modern Standby (MS), which is a power management feature introduced by Microsoft^{®}. In general, MS is intended to improve battery life and the transition between power states, allowing Windows^{®} computers to quickly resume from sleep or hibernation states, similar to smartphones. As typically implemented, MS provides more power directly to the CPU 602 of an IHS, compared to traditional Microsoft^{®} S3 standby, which only stores information in the memory of the IHS 1100.

However, various embodiments of the invention reflect an appreciation that additional power may be consumed when certain components of an IHS 1100, such as its CPU 602, DMA controller 1112, Network Interface Card (NIC) controllers (not shown), and related drivers (also not shown), may remain powered on when operating in MS mode. In particular, a mobile IHS 1100, such as a laptop computer, may experience accelerated battery drain when it is in MS Connected mode, which may in turn lead to accelerated battery depletion, system shutdown, interruption in network connectivity, or potential data loss, or a combination thereof. Likewise, various embodiments of the invention reflect an appreciation that both virtual 1118 and physical memory 1114, 1116 addresses become mapped with network packets, and certain associated input/output (I/O) operations, when an IHS 1100 enters MS mode and memory utilization is running, which typically results in associated operational costs and power drain.

Referring now to FIG. 11, an IHS 1100 may be implemented in various embodiments to enter 1124 MS mode. In various embodiments, the operation of one or more CPUs 602, one or more storage controllers 1108, and the DMA controller 1112 may be controlled when it the IHS 1100 is operating in MS mode. In various embodiments, the one or more storage controllers 1108 may be implemented to be operating 1126 in running mode once the IHS 1100 has entered 1124 MS mode. Likewise, power consumption may be increased in various embodiments with full DMA 1112 memory operating 1128 in running mode once the IHS 1100 has entered 1124 MS mode.

In various embodiments, the IHS 1100 may be implemented to exit 1130 MS mode. In various embodiments, certain user data may be copied from one storage device 1110 to another once the IHS 1100 exits 1130 MS mode. In certain of these embodiments, the copying 1122 of the data from one memory device 1110 to another may be performed with the IHS 1100 operating under full power.

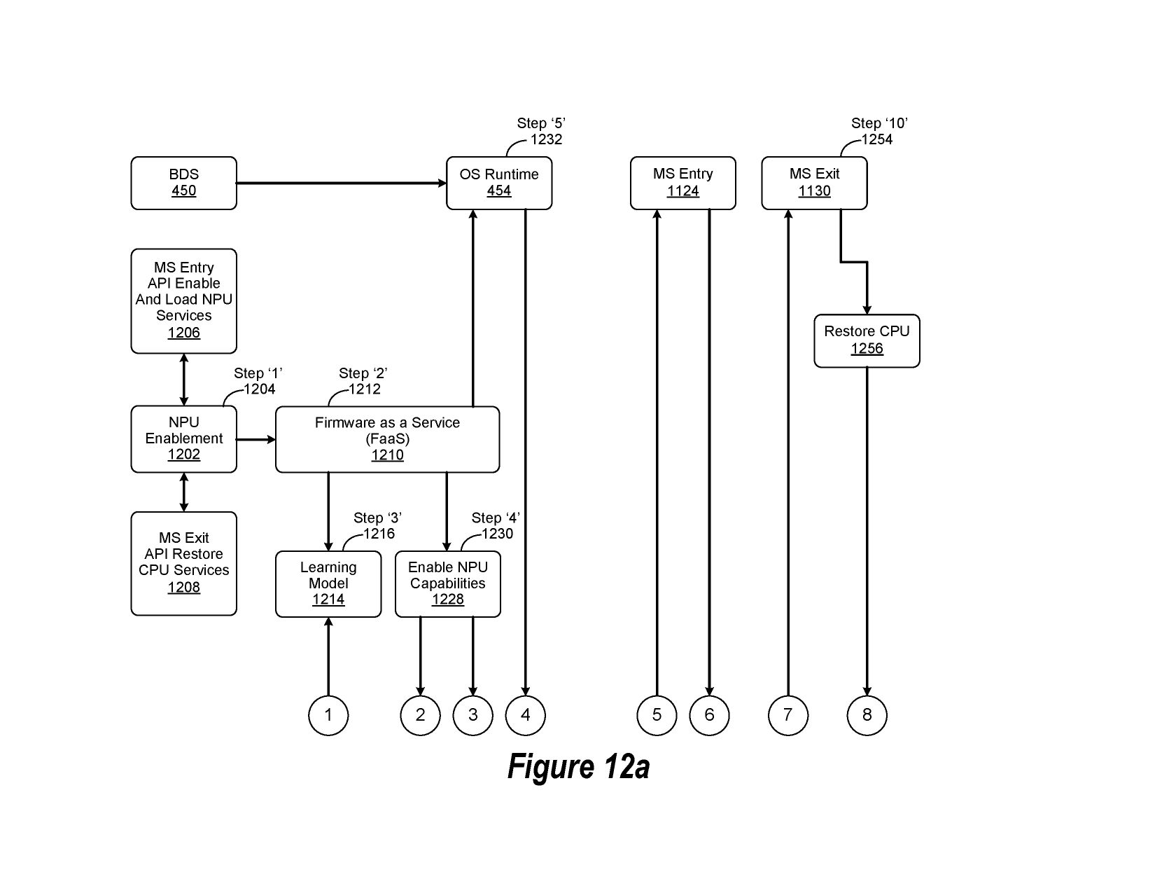

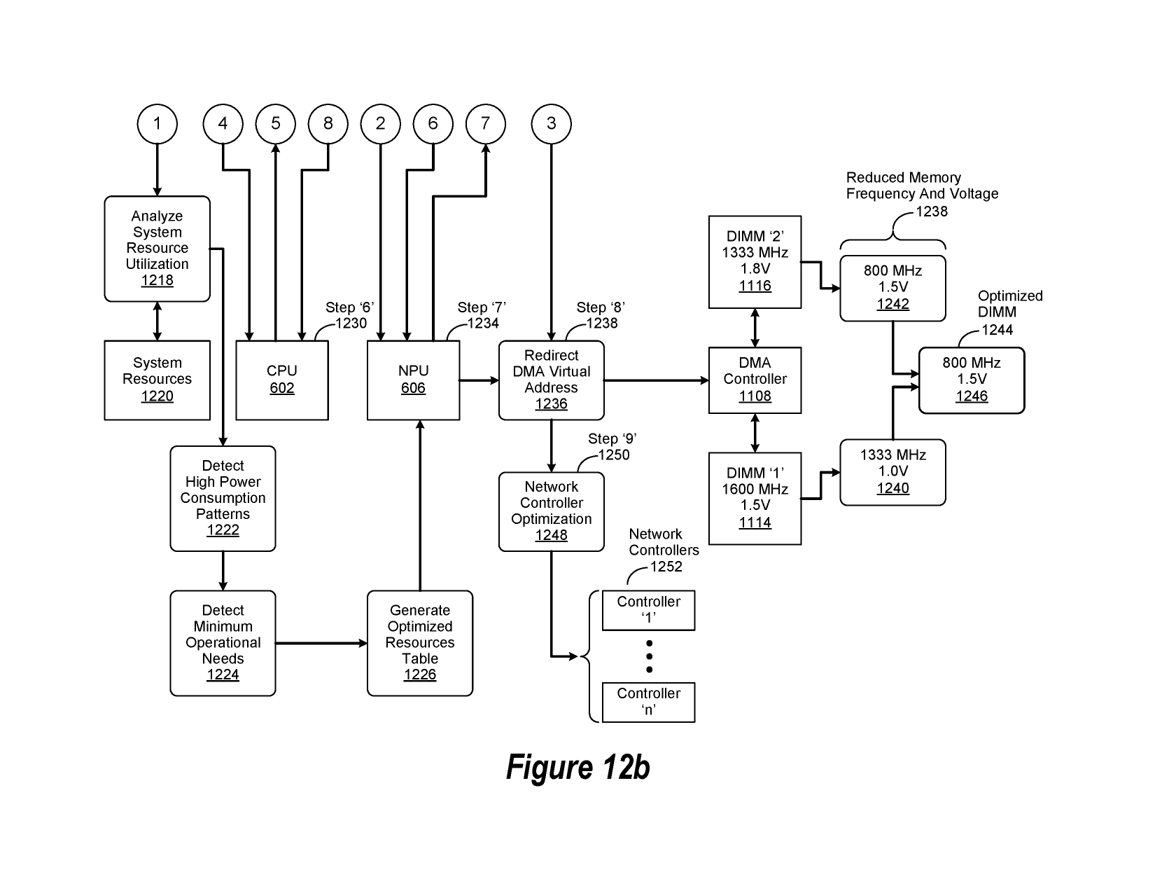

FIGS. 12a and 12b are a simplified block diagram of the architecture of a Firmware as a Service (FaaS) framework implemented in accordance with an embodiment of the invention to enable power-efficient Modern Standby (MS) operations. In various embodiments, the performance of certain System on Chip (SoC) controllers may be optimized by using the capabilities of one or more Neural Processing Units (NPUs), described in greater detail herein, to invert the typical hardware-based approach for an information handling system (IHS) entering Modern Standby (MS) mode, likewise described in greater detail herein. In various embodiments, one or more Cryptographic Acceleration Management (CAM) operations, described in greater detail herein, may be performed to achieve context-aware learning to analyze system resource utilization, identify high-power consumption patterns during MS mode entry and exit, and detect the bare minimum operations necessary for maintaining connectivity. In certain of these embodiments, various factors may be considered, such as battery state, active controllers, available resources, Direct Memory Access (DMA) controller frequency, real memory utilization, network communication activity, and so forth.

In various embodiments, one or more CAM operations may be performed to generate a context-aware learning model based upon current battery state and projected utilization, which controllers are currently operating, available resources, frequency of the DMA controller, real memory utilization network communication activity, network packet traffic patterns, and so forth. As used herein, context awareness broadly refers to a capability of an IHS to sense and react based upon information associated with its operating environment. As likewise used herein, adaptive context awareness broadly refers to a capability of the IHS to sense and react based upon information associated with the information handling system environment which adjusts based upon one or more conditions associated with the information handling system environment.

In various embodiments a CAM operation may be implemented to include the performance of one or Firmware as a Service (FaaS) operation. As used herein, an FaaS operation broadly refers to any function, task, procedure, or process performed, directly or indirectly, within a multi-processor operating environment, or an architecture-specific distributed firmware management platform (ASDFMP), both of which are described in greater detail herein, to provide certain firmware components, or the management thereof, on-demand as a service. In various embodiments, one or more CAM operations may be performed to enable the use of certain functionalities and capabilities provided by the performance of one or more FaaS operations when an IHS is entering or exiting MS mode.

In various embodiments, one or more CAM operations may be performed to implement certain FaaS functionalities and capabilities during MS mode entry to dynamically redirect DMA virtual address from utilizing multiple (e.g., use of two) Dual In-Line Memory Modules (DIMMs) to optimized (e.g., use of one) DIMM operation. In various embodiments, one or more CAM operations may be performed to provide certain FaaS functionalities and capabilities during MS mode exit, to facilitate seamless restoration of workload context from NPU operations to CPU utilization. For example, the system’s Operating System (OS) may have no way of knowing it is using an NPU instead of its CPU unless it returns to MS mode. As a result, the OS will assume that its CPU is still being utilized and consuming power.

In various embodiments, one or more CAM operations may be performed to dynamically enable NPU capabilities while reducing Central Processing Unit (CPU) utilization. In various embodiments, one or more CAM operations may be performed to enable one or more NPUs to operate in a more power-efficient context and to ensure seamless context switching back to the CPU during MS mode exit. In various embodiments, one or more CAM operations may be performed to utilize one or more NPUs to learn system utilization and offload memory, network, solid state drive (SSD), and Non-Volatile Memory express (NVMe) operations to reduce CPU utilization. In various embodiments, one or more CAM operations may be performed to reduce the network traffic activity, based upon system context, limit Wireless Fidelity (Wi-Fi) or wired network packet processing, shift from high network bandwidth (e.g., 5G) to low bandwidth (e.g., 2G) operations, reduce solid state drive (SSD) and NVMe controller block Input/Output (IO) operation activity, and so forth.

In various embodiments, one or more CAM operations may be performed at the boot device selection (BDS) pre-boot phase to expose certain Application Program Interfaces (APIs) at runtime, which can be then be used at MS mode entry and exit to dynamically change the IHS’s configuration. In various embodiments, one or more CAM operations may be performed to enable a firmware node at the Boot Device Selection (BDS) pre-boot phase to initialize NPU capabilities for MS mode entry and exit. In various embodiments, one or more CAM operations may be performed to expose certain APIs at runtime, which can then be used at MS mode entry and exit. In various embodiments, one or more CAM operations may be performed to redirect DMA virtual addresses, change Memory frequency, and reduce network communication activity, or a combination thereof.

Referring now to FIGS. 12a and 12b, one or more FaaS operations may be initiated by enabling 1202 the operation of one or more NPUs during step ‘1’ 1204. In various embodiments, the enablement 1202 of the operation of the one or more NPUs may be implemented to use an API associated with the one or more NPUs to load 1206 certain NPU services when the IHS enters MS mode. In various embodiments, the enablement 1202 of the operation of the one or more NPUs may likewise be implemented to use an API associated with the one or more NPUs to restore 1208 certain CPU services when the IHS exits MS mode. Likewise, the enablement 1202 of the operation of the one or more NPUs may be implemented in various embodiments to perform certain FaaS 1210 operations, or provide certain functionalities or capabilities resulting therefrom, in step ‘2’ 1212.

In various embodiments, one or more FaaS 1210 operations may be performed in step ‘3’ 1216 to generate a learning model 1214. In various embodiments, the resulting learning model 1214 may be implemented to be used to perform an analysis 1220 of system resource utilization 1218. In various embodiments, the system resource utilization analysis 1218 may be performed in various embodiments to detect 1222 high power consumption patterns.

In various embodiments, the system resource utilization analysis 1218 may likewise be performed in various embodiments to detect 1224 minimum operational needs of the IHS. In various embodiments, one or more FaaS 1210 operations may be performed to generate 1226 an optimized resources table from the results of the system resource utilization analysis 1218. In various embodiments, one or more FaaS 1210 operations may be performed to provide the previously-generated 1226 optimized resources to one or more NPUs 606.

In various embodiments, one or more FaaS 1210 operations may be performed in step ‘4’ 1230 to enable 1228 certain NPU capabilities. In various embodiments, as described in greater detail herein, a boot device (not shown) may be used during the Boot Device Selection (BDS) 450 pre-boot phase of the IHS’s operation to enable it to enter an OS runtime phase 454 in step ‘5’ 1232. In various embodiments, one or more FaaS 1210 operations may be performed during the IHS’s OS runtime phase 454 to access one or more of its CPUs 602 in step ‘6’ 1230. In certain of these embodiments, the one or more CPUs may then be implemented to enter 1124 the IHS into MS mode.

Once the IHS has entered 1124 MS mode, the one or more enabled 1228 NPUs 606 may be implemented in various embodiments to redirect 1236 certain DMA virtual memory addresses in step ‘7’ 1234. The redirected 1236 DMA virtual memory addresses may then be used in various embodiments to interact with the DMA controller 1108 of the IHS in step ‘8’ 1238. In various embodiments, the DMA controller 1108 may be used in the performance of one or more FaaS operations to first determine the respective frequency and operating voltages of DIMMs ‘1’ 1114 and ‘2’ 1116. In various embodiments, one or more FaaS 1210 operations may be performed to respectively reduce 1238 the frequency and voltage of DIMMs ‘1’ 1240 and ‘2’ 1242. In various embodiments, one or more FaaS 1210 operations may be performed to determine 1244 an optimized DIMM frequency and voltage setting 1246.

In various embodiments, the redirected 1236 DMA virtual memory addresses may likewise be used to optimize 1248 one or more network controllers ‘1’ through ‘n’ 1252 in step ‘9’ 1250. In various embodiments, one or more FaaS 1210 operations may be performed by the one or more NPUs 606 to exit 1130 the IHS from MS mode in step ‘10’ 1254. Thereafter, one or more FaaS 1210 operations may be performed to restore 1256 of the IHS’s CPU 602.

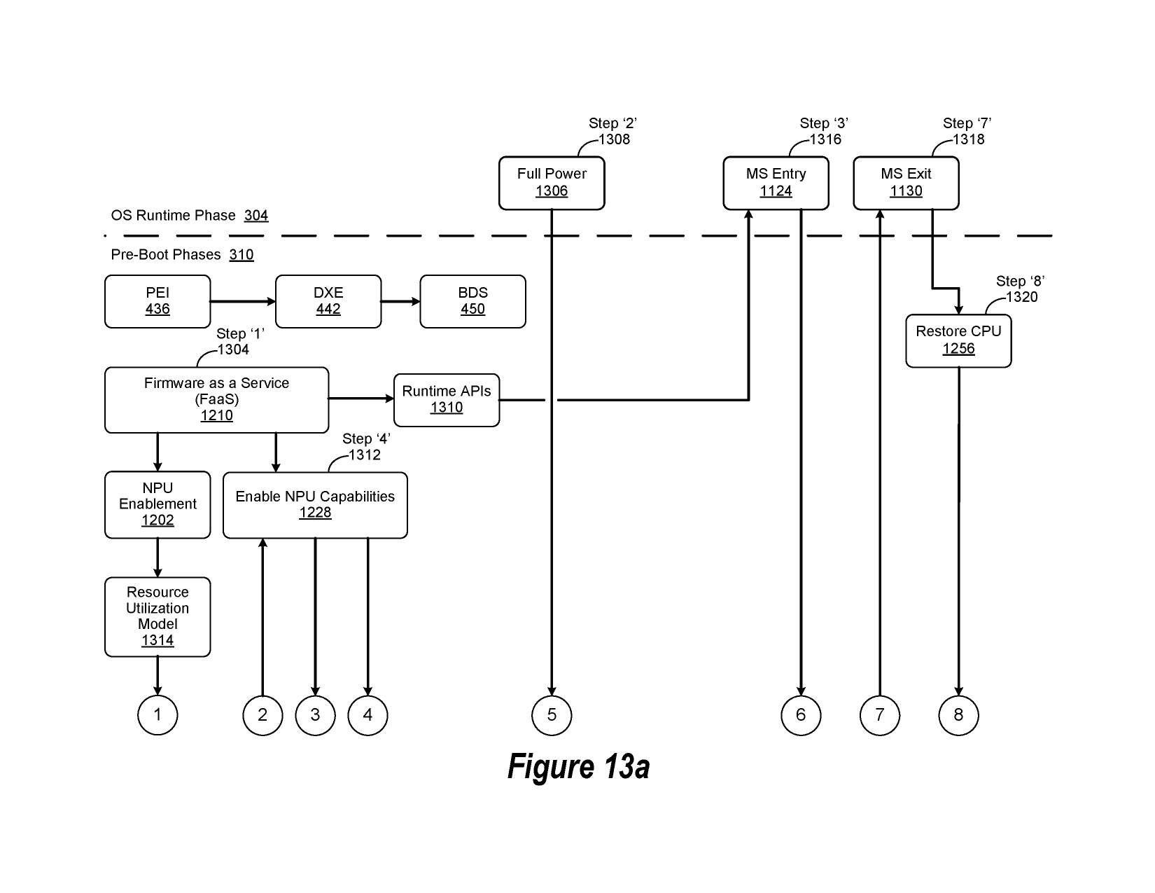

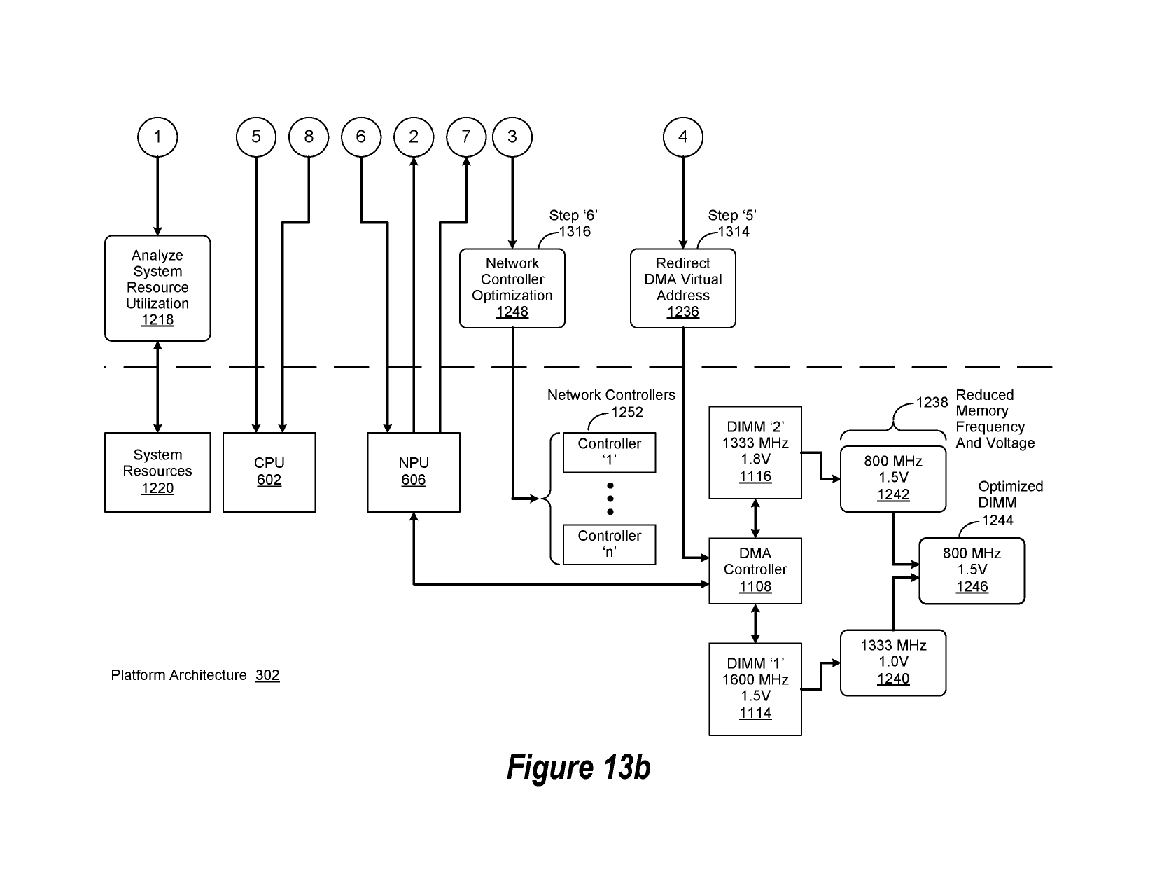

FIGS. 13a and 13b are a simplified block diagram showing the performance of certain Firmware as a Service (FaaS) operations to enable power-efficient Modern Standby (MS) operations. In various embodiments, one or more cryptographic acceleration management (CAM) operations, described in greater detail herein, may be performed to enable context-aware learning for analyzing system resource utilization. In various embodiments, such analysis of system resource utilization may be used to identify high-power consumption patterns during MS mode entry and exit, and detecting minimum operations necessary for maintaining connectivity, or a combination of the two. In certain of these embodiments, factors such as battery state, active controllers, available resources, Direct Memory Access (DMA) controller frequency, real memory utilization, and network activity levels may be considered. In various embodiments, one or more CAM operations may be performed to enable certain FaaS functionalities and capabilities, likewise described in greater detail herein.

In various embodiments, one or more CAM operations may be performed to dynamically enable Neural Processing Unit (NPU) capabilities to reduce Central Processing Unit (CPU) load while enabling NPUs to run more power efficiently in MS mode entry and exit, while also allowing seamless context switching back to the CPU during MS exit. In various embodiments, one or more CAM operations may be performed to enable certain FaaS functionalities and capabilities during MS mode entry by dynamically redirecting DMA virtual address from utilizing multiple (e.g., use of two) Dual Inline Memory Modules (DIMMs) to optimized (e.g., use of one) DIMM operation. In various embodiments, one or more CAM operations may be performed to reduce network traffic loads, based upon the system context, limiting Wireless Fidelity (Wi-Fi) or wired network packet processing, and shifting from high network bandwidth (e.g., 5G) to low bandwidth (e.g., 2G) operations, or a combination thereof. Various embodiments of the invention reflect an appreciation that the implementation of FaaS during MS mode exit may facilitate a seamless restore of workload context from NPU operations to CPU utilization. In various embodiments, one or more CAM operations may be performed during the boot device selection (BDS) pre-boot phase of an IHS to expose certain Application Program Interface (APIs) at runtime, which can then be used during MS mode entry and exit to dynamically change system configuration.

Referring now to FIGS. 13a and 13b, an IHS may be implemented in various embodiments to include an OS runtime phase 304, various pre-boot phases 310, and a platform architecture 302. In various embodiments, the pre-boot phases 310 may include a security a Pre Extensible Firmware Interface (EFI) Initialization (PEI) 436 phase, a Driver eXecution Environment (DXE) 442 phase, and a BDS 450 phase, as described in greater detail herein. In various embodiments, as likewise described in greater detail herein, the platform architecture 302 may be implemented to include certain system resources 1220, one or more CPUs 602, one or more NPUs 606, one or more network controllers ‘1’ through ‘n’ 1252, a DMA controller 1108, one or more DIMMs ‘1’ 1114, ‘2’ 1116, and so forth, or a combination thereof.

In various embodiments, one or more FaaS 1210 operations may be initiated by enabling 1202 the operation of one or more NPUs 606 during step ‘1’ 1304. In various embodiments, the enablement 1202 of the operation of the one or more NPUs 606 may be utilized in the performance of one or more FaaS 1210 operations to generate a resource utilization model 1314. In various embodiments, one or more FaaS 1210 operations may be performed to perform an analysis 1218 of system resources 1220. In various embodiments, the resulting analysis 1218 of system resources 1220 may be used in the one or more FaaS 1210 operations performed to generate the resource utilization model 1218.

In various embodiments, the IHS may be implemented to enter a full power mode 1306 in step ‘2’ 1308 to initialize the operation of one or more CPUs 602. In various embodiments, one or more FaaS 1210 operations may be performed to use one or more runtime APIs 1310 in step ‘3’ 1316 to load certain NPU services associated with the one or more NPUs 606 when the IHS enters 1124 MS mode. In various embodiments, one or more FaaS 1210 operations may be performed in step ‘4’ 1312 to enable 1228 certain NPU capabilities. In various embodiments, the enablement 1228 of certain NPU capabilities in step ‘4’ 1312 may be used in the performance of one of more FaaS 1210 operations to redirect 1236 certain DMA virtual memory addresses in step ‘5’ 1314.

The redirected 1236 DMA virtual memory addresses may then be used in various embodiments to interact with the DMA controller 1108 of the IHS. In various embodiments, the DMA controller 1108 may be used in the performance of one or more FaaS 1210 operations to first determine the respective frequency and operating voltages of DIMMs ‘1’ 1114 and ‘2’ 1116. In various embodiments, one or more FaaS operations may be performed to respectively reduce 1238 the frequency and voltage of DIMMs ‘1’ 1240 and ‘2’ 1242. In various embodiments, one or more FaaS operations may be performed to determine 1244 an optimized DIMM frequency and voltage setting 1246.

In various embodiments, the enablement 1228 of certain NPU capabilities in step ‘4’ 1312 may be used in the performance of one of more FaaS 1210 operations to optimize 1248 one or more network controllers ‘1’ through ‘n’ 1252 in step ‘6’ 1316. In various embodiments, one or more FaaS 1210 operations may be performed by the one or more NPUs 606 to exit 1130 the IHS from MS mode in step ‘7’ 1318. Thereafter, one or more FaaS 1210 operations may be performed in step ‘8’ 1320 to restore 1256 operation of the IHS’s CPU 602.

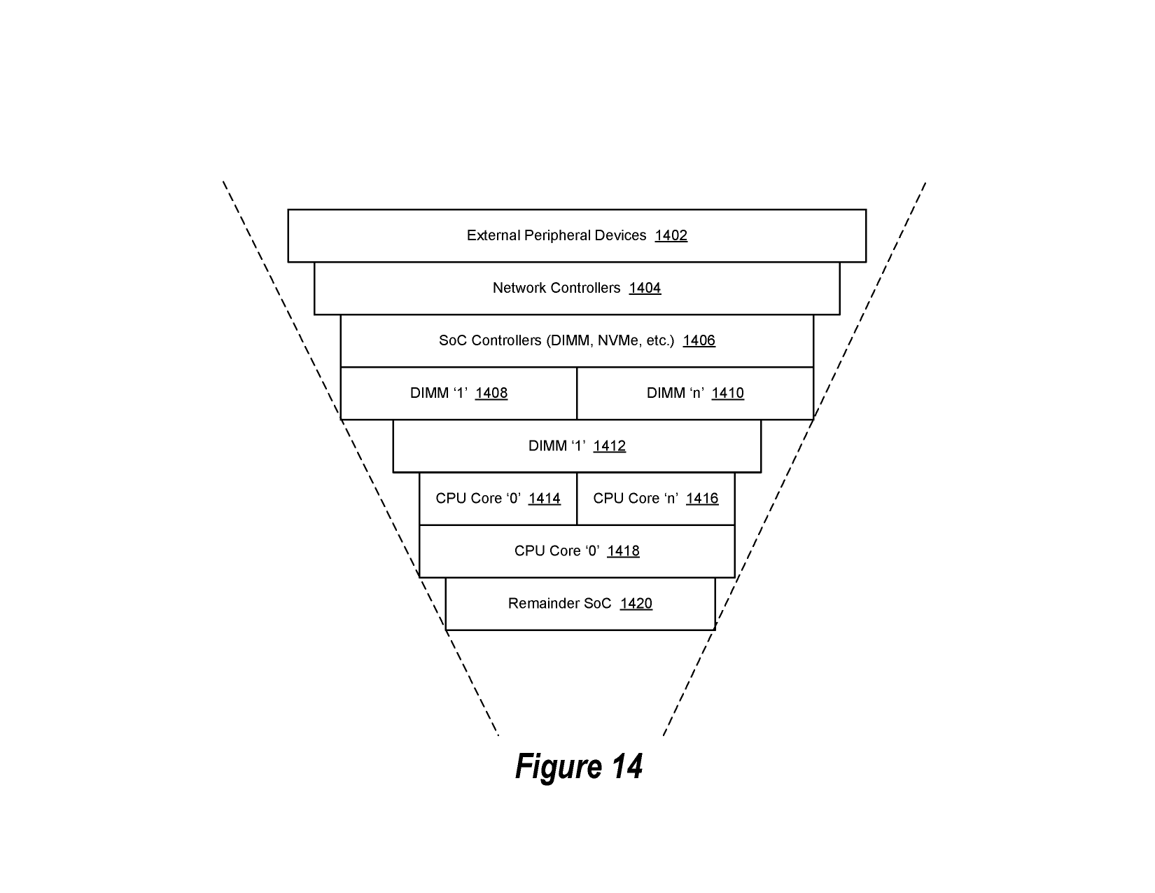

FIG. 14 is a simplified block diagram showing the prioritization of power optimization for certain information handling system (IHS) components implemented in accordance with an embodiment of the invention. In various embodiments, one or more Firmware as a Service (FaaS) operations, described in greater detail herein, may be performed to determine the prioritization of power optimization for certain IHS components. As an example, as shown in FIG. 14, the IHS’s external peripheral devices 1402, followed by its associated network controllers 1404, may be prioritized as the result of the performance of one or more FaaS operations.

Likewise, the IHS’s System On Chip (SoC) controllers 1406 for its Dual Inline Memory Modules (DIMMs), Non-Volatile Memory Express (NVMe) controllers, and so forth, may then be prioritized. In various embodiments, the IHS may be implemented to include two or more DIMM modules ‘1’ 1408 through ‘n’ 1410. In various embodiments, one of more FaaS operation may be performed to determine that DIMM module ‘1’ 1412 may receive prioritization for power optimization.

Likewise, In various embodiments, the IHS may be implemented to include two or more Central Processing Unit (CPU) cores ‘0’ 1414 through ‘n’ 1416. In various embodiments, one of more FaaS operation may be performed to determine that CPU core ‘0’ 1418 may receive prioritization for power optimization. In various embodiments, one of more FaaS operation may likewise be performed to determine the remainder 1420 of the SoC’s components then receive prioritization for power optimization.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture; and,
performing a cryptographic acceleration management operation, the cryptographic acceleration management operation accelerating performance of a cryptographic operation.

2. The method of claim 1, wherein:
the processor environment installed on the information handling system includes a neural processing unit; and,
the neural processing unit performs the cryptographic acceleration management operation.

3. The method of claim 1, wherein:
the cryptographic acceleration management operation creates a cryptographic acceleration framework.

4. The method of claim 3, wherein:
the cryptographic acceleration framework is used when performing the cryptographic acceleration management operation to generate a cryptographic light-weighted firmware object.

5. The method of claim 1, wherein:
the cryptographic acceleration management operation generates a context-aware learning model.

6. The method of claim 5, wherein:
the context-aware learning model is based upon one or more of current battery state and projected utilization, which controllers are currently operating, available resources, frequency of a DMA controller, real memory utilization network communication activity, and network packet traffic patterns.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS;
identifying a processor environment installed on an information handling system from a plurality of processor environments, the processor environment comprising a processor architecture;
performing a cryptographic acceleration management operation, the cryptographic acceleration management operation accelerating performance of a cryptographic operation.

8. The system of claim 7, wherein:
the processor environment installed on the information handling system includes a neural processing unit; and,
the neural processing unit performs the cryptographic acceleration management operation.

9. The system of claim 7, wherein:
the cryptographic acceleration management operation creates a cryptographic acceleration framework.

10. The system of claim 8, wherein:
the cryptographic acceleration framework is used when performing the cryptographic acceleration management operation to generate a cryptographic light-weighted firmware object.

11. The system of claim 7, wherein:
the cryptographic acceleration management operation generates a context-aware learning model.

12. The system of claim 11, wherein:
the context-aware learning model is based upon one or more of current battery state and projected utilization, which controllers are currently operating, available resources, frequency of a DMA controller, real memory utilization network communication activity, and network packet traffic patterns.

13. A non-transitory, computer-readable storage medium embodying computer program code, the computer program code comprising computer executable instructions configured for:
providing an information handling system with a distributed BIOS;
identifying a processor environment installed on an information handling system from a plurality of processor environments, the processor environment comprising a processor architecture;
performing a cryptographic acceleration management operation, the cryptographic acceleration management operation accelerating performance of a cryptographic operation.

14. The non-transitory, computer-readable storage medium of claim 13, wherein:
the processor environment installed on the information handling system includes a neural processing unit; and,
the neural processing unit performs the cryptographic acceleration management operation.

15. The non-transitory, computer-readable storage medium of claim 13, wherein:
the cryptographic acceleration management operation creates a cryptographic acceleration framework.

16. The non-transitory, computer-readable storage medium of claim 15, wherein:
the cryptographic acceleration framework is used when performing the cryptographic acceleration management operation to generate a cryptographic light-weighted firmware object.

17. The non-transitory, computer-readable storage medium of claim 13, wherein:
the cryptographic acceleration management operation generates a context-aware learning model.

18. The non-transitory, computer-readable storage medium of claim 17, wherein:
the context-aware learning model is based upon one or more of current battery state and projected utilization, which controllers are currently operating, available resources, frequency of a DMA controller, real memory utilization network communication activity, and network packet traffic patterns.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
